(19) United States
(12) Patent Application Publication
(10) Pub. No.: US 2002/0133418 A1
(43) Pub. Date: Sep. 19, 2002

(54) Transaction systems and methods wherein a portable customer device is associated with a customer

(76) Inventors: Keith J. Hammond, Jackson, MS (US); Walter T. Griffin, Madison, MS (US); Sonja Vanessa Wallace Taylor, Jackson, MS (US)

Correspondence Address: BUCKLEY, MASCHOFF, TALWALKAR, & ALLISON, 5 ELM STREET, NEW CANAAN, CT, 06840, US

(21) Appl. No.: 09/809,799

(22) Filed: Mar. 16, 2001

(51) Int. Cl. G06F 17/60

(52) U.S. Cl. 705/26

(57) ABSTRACT

Transaction systems and methods are provided wherein a portable customer device is associated with a customer. For example, a portable digital assistant may be provided to, and associated with, the customer when he or she enters a restaurant. According to one embodiment, order information is received from the customer via the portable customer device. For example, the customer may select one or more food items from a menu displayed on the portable customer device before he or she is seated at a table. An item may then be provided to the customer in response to the order information.

### FIELD

The present invention relates to customer transactions. In particular, the present invention relates to transaction systems and methods wherein a portable customer device is associated with a customer.

### BACKGROUND

Traditionally, a customer who visits a restaurant may need to wait before he or she is seated at a table. Once seated at the table, the customer generally again waits for a waitperson to provide them with a menu (and perhaps take a drink order). The customer reviews the menu, and waits for the waitperson to return. When the waitperson returns, the customer then places his or her main order order.

Thus, a significant amount of time may pass between the time a customer enters a restaurant and the time the customer actually places his or her main order. Moreover, much of this time is spent waiting at a table (e.g., waiting for a menu or waiting for the waitperson). As a result, the number of customers that can be served at the restaurant (and thus the amount of profit the restaurant may make) is significantly restricted.

Moreover, after a customer has finished eating, he or she will typically have to wait before leaving the table. For example, the customer may need to request a check, review the check, provide a credit card to a waitperson, and wait for the credit card to be approved. This represents additional time that the customer is waiting at the table, further restricting the maximum number of customers that can be served at the restaurant.

For example, consider a restaurant having twenty tables. If the restaurant is open for six hours during the day, and each customer spends (on average) one hour at a table, the restaurant will only be able to serve a maximum of 120 customers each day (assuming that a single customer sits at each table). If, however, each customer could be served such that he or she spends only 45 minutes at a table, the restaurant could instead serve up to 160 customer each day.

The traditional method of serving a restaurant customer has other disadvantages as well. For example, a customer may make a mistake when providing his or her order to a waitperson. Similarly, the waitperson may make a mistake when taking the order or when relaying the order to other employees (e.g., employees who work in the kitchen). Such mistakes result in a significant amount of re-work and waste in restaurants.

It is known that a restaurant may provide an electronic ordering device attached to a table in the restaurant. Although such a device may reduce mistakes, the amount of time wasted before a customer places an order would still be significant. It is also known that a customer may use his or her own electronic device, such as his or her Personal Digital Assistant (PDA), to place an order in a fast-food restaurant. However, many customers do not have such electronic devices. Moreover, some customers may have devices that are not compatible with the restaurant's ordering system.

### SUMMARY

To alleviate the problems inherent in the prior art, the present invention introduces transaction systems and methods wherein a portable customer device is associated with a customer.

According to one embodiment of the present invention, a portable customer device is associated with a customer. Order information is received from the customer via the portable customer device, and an item is provided to the customer in response to the order information.

According to another embodiment, directed to facilitating restaurant transactions, a PDA is provided to and associated with a customer. A dynamically generated menu is transmitted to the PDA, and a customer order is received from the PDA. The customer order may comprise, for example, a list of food items selected from the dynamically generated menu. Order information is then transmitted to at least one restaurant employee (e.g., an employee in the restaurant's kitchen). The customer may then be associated with a table location (e.g., a table number), and the selected food items are provided to the customer at the table location in response to the order information. A total payment amount is calculated based on the selected food items, and it is arranged for the customer to provide payment of the total payment amount.

One embodiment of the present invention is directed to a portable customer device adapted to be used in a transaction system as described herein. Another embodiment is directed to a controller adapted to be used in such a transaction system. Still another embodiment is directed to the transaction system (e.g., including the controller and a number of portable customer devices).

Another embodiment is directed to a method of placing an order in a restaurant. A portable customer device is received from the restaurant, and a customer arranges to be associated with the portable customer device. Order information is provided via the portable customer device, and an item is received in response to the order information.

One embodiment of the present invention comprises: means for associating a portable customer device with a customer; means for receiving order information from the customer via the portable customer device; and means for providing an item to the customer in response to the order information.

Another embodiment comprises: means for providing a PDA to a customer; means for associating the PDA with the customer; means for transmitting a dynamically generated menu to the PDA; means for receiving a customer order from the PDA, the customer order comprising a list of food items selected from the dynamically generated menu; means for transmitting order information to at least one restaurant employee; means for associating the customer with a table location; means for providing the selected food items to the customer at the table location in response to the order information; means for calculating a total payment amount based on the selected food items; and means for arranging for the customer to provide payment of the total payment amount.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1A is a block diagram overview of a transaction system according to an embodiment of the present invention.

FIG. 1B is a flow chart of a method for facilitating transactions according to an embodiment of the present invention.

FIG. 2A is a block diagram overview of a restaurant transaction system according to another embodiment of the present invention.

FIG. 2B is a flow chart of a method for facilitating restaurant transactions according to another embodiment of the present invention.

FIG. 3 is a block diagram of a portable customer device according to an embodiment of the present invention.

FIG. 4 is a block diagram of a controller according to an embodiment of the present invention.

FIG. 5 is a tabular representation of a portion of a device database according to an embodiment of the present invention.

FIG. 6 is a tabular representation of a portion of a customer database according to an embodiment of the present invention.

FIG. 7 is a tabular representation of a portion of a location database according to an embodiment of the present invention.

FIG. 8 is a tabular representation of a portion of an inventory database according to an embodiment of the present invention.

FIG. 9 is a tabular representation of a record in a menu database according to an embodiment of the present invention.

FIG. 10 is a tabular representation of a record in a transaction database according to an embodiment of the present invention.

FIG. 11 is a detailed diagram of a restaurant transaction system according to an embodiment of the present invention.

FIG. 12 is a customer state diagram according to an embodiment of the present invention.

FIGS. 13 to 21 are customer information flow diagrams according to an embodiment of the present invention.

FIG. 22 is a customer state diagram according to another embodiment of the present invention.

FIG. 23 is a customer information flow diagram according to another embodiment of the present invention.

FIG. 24 is an employee state diagram according to an embodiment of the present invention.

FIGS. 25 to 30B are employee information flow diagrams according to an embodiment of the present invention.

FIGS. 31A and 31B illustrate portable customer devices displaying information according to some embodiments of the present invention.

### DETAILED DESCRIPTION

Embodiments of the present invention are directed to transaction systems and methods wherein a portable customer device is associated with a customer.

### Transaction System Overview

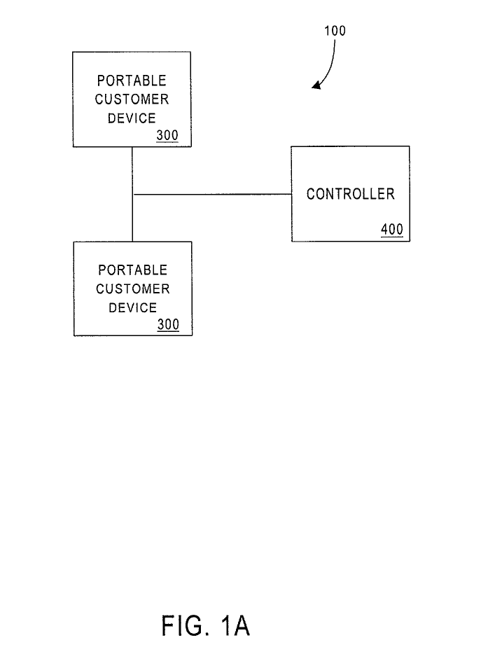

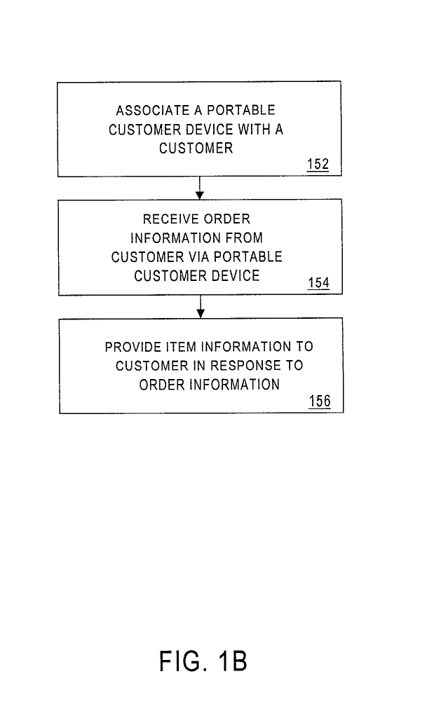

Turning now in detail to the drawings, FIG. 1A is a block diagram of a transaction system 100 according to one embodiment of the present invention. The transaction system 100 includes a controller 400 in communication with a number of portable customer devices 300. As used herein, devices (such as the portable customer devices 300 and the controller 400) may communicate, for example, via a communication network, such as an Ethernet network, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet. Moreover, as used herein, communications include those enabled by wired or wireless technology. Note that although a single controller 400 is shown in FIG. 1A, any number of controllers 400 may be included in the transaction system 100. Similarly, any number of the other devices described herein may be included in the transaction system 100 according to embodiments of the present invention.

In one embodiment of the present invention, a portable customer device 300 communicates with a remote, Web-based controller 400 (e.g., a server) via the Internet. Although some embodiments of the present invention are described with respect to information exchanged using a Web site, according to other embodiments information can instead be exchanged, for example, via: a telephone, an Interactive Voice Response Unit (IVRU), electronic mail, and/or a wireless communication system.

The portable customer device 300 and the controller 400 may be any devices capable of performing the various functions described herein. The portable customer device 300 may be, for example: a PDA, a wired or wireless telephone, a one-way or two-way pager, or any other appropriate storage and/or communication device. According to one embodiment, the portable customer device 300 also includes, or is in communication with, a portable printing device.

Note that the devices shown in FIG. 1A need not be in constant communication. For example, a portable customer device 300 may only communicate with the controller 400 when appropriate (e.g., via an infrared device when near a receiving device coupled to the controller 400). Note also that, according to some embodiments, a portable customer device 300 and the controller 400 may be incorporated in a single device (e.g., a kiosk may act as both a portable customer device 300 and the controller 400).

According to an embodiment of the present invention, a customer uses a portable customer device 300 to communicate with the controller 400. For example, a customer may use a PDA to access a Web site associated with the controller 400 to view a menu and to place a food order in a restaurant. In this case, the controller 400 may update inventory information and/or an account associated with the customer.

FIG. 1B is a flow chart of a method for facilitating transactions via the transaction system 100 according to an embodiment of the present invention. The flow charts in FIG. 1B and the other figures described herein do not imply a fixed order to the steps, and embodiments of the present invention can be practiced in any order that is practicable. Moreover, the methods may be performed by any of the devices described herein, including a controller 400 and/or a portable customer device 300.

At 152, a portable customer device 300 is associated with a customer. For example, a portable customer device 300 may be given to a customer when he or she enters a restaurant. In this case, a payment identifier may be received from the customer to secure the portable customer device 300. For example, a customer may need to provide a credit card number to secure the portable customer device 300. The restaurant can then apply a penalty to the customer's credit card account if he or she fails to return the portable customer device 300. According to another embodiment, the portable customer device 300 includes a retailer tag that will set off an alarm if the unit is removed from the restaurant.

The portable customer device 300 may be “associated” with a customer, for example, when the controller 400 stores a customer identifier in association with a device identifier. Note that the portable customer device 300 may be associated with the customer before the customer is associated with a location, such as a particular restaurant table (e.g., a particular table number) or a restaurant area (e.g., a bar or waiting area).

According to one embodiment of the present invention, item information is transmitted to the customer via the portable customer device 300. For example, a dynamically generated menu listing a number of different food items may be transmitted from the controller 400 to the portable customer device 300. The item information may comprise, for example, text information (e.g., describing an appetizer), audio information (e.g., a record message describing an entrée), and/or image information (e.g., a picture of dessert or a video showing how the dessert is prepared). Note that the menu may be dynamically generated based on, for example, inventory information (e.g., items may be omitted or prices may be reduced based on inventory information) and/or information about a particular customer (e.g., the customer's prior transactions or preferences).

The item information transmitted to the portable customer device 300 may include, for example, an item description, an item price, an item suggestion, and/or an item discount or other special offer. For example, based on a customer's past purchasing history, the item information may suggest that the customer order a particular dessert at a 20% discount.

At 154, order information is received from the customer via the portable customer device 300. For example, the customer may use his or her portable customer device 300 to transmit a list of food item selections to the controller (e.g., by using a touch-screen or microphone incorporated in a PDA). The order information may include, for example, a food order, a service order (e.g., requesting that empty dishes be removed from a table), an order update (e.g., substituting a previously requested entrée), an order cancellation, customer preference information (e.g., indicating that he or she enjoyed a particular appetizer and would like to be offered that appetizer again the next time he or she visits the restaurant), timing information associated with an order (e.g., “please bring an order from the children's menu as soon as it is ready”), customer satisfaction information (e.g., rating a food item or an employee's service), a search request (e.g., “show me all entrées that do not have MSG as an ingredient”), and/or an item information request (e.g., asking how a particular entrée is prepared).

Note that the order information may be received from the portable customer device 300 before the customer is associated with a location, such as a particular restaurant table.

According to one embodiment of the present invention, the controller 400 updates inventory information based on the order information. For example, the controller 400 may decrease a number of available soup portions when a customer orders a bowl of soup. According to another embodiment, the inventory information is instead updated when an item is actually provided to a customer (and not when the customer orders the item).

At 156, an item is provided to the customer in response to the order information. For example, the controller 400 may arrange for a food item to be prepared and delivered to a customer based on his or her order information. According to an embodiment of the present invention, the item may be provided to the customer before he or she is associated with a location (e.g., with a table location). For example, a customer may receive a drink or food item while he or she waits in a bar area.

According to another embodiment, the customer may be associated with a location after providing order information but before he or she receives an item. In this case, the controller 400 may arrange for the item to be delivered to the location that is now associated with the customer (e.g., directly to the customer's table). The controller 400 may determine a current location associated with a customer based on, for example, information received from the customer, information received from an employee (e.g., a waitperson), information received from the portable customer device 300 (e.g., the portable customer device 300 may be adapted to transmit location information to the controller 400), and/or information received from a table device (e.g., a device that detects when a particular portable customer device 300 is present at the table).

The “item” provided to the customer may comprise, for example, a food item (e.g., an entrée or appetizer). The item may also comprise a service. For example, a customer may ask to speak to a manager.

According to another embodiment, a supplemental service may be provided to the customer via the portable customer device 300. For example, the customer may be allowed to access entertainment information (e.g., music or video information) while he or she waits to be seated or even while dining. Similarly, a customer may be allowed to play a game using the portable customer device 300. According to one embodiment, it is arranged for the customer to provide payment in exchange for the supplemental service.

According to one embodiment of the present invention, a message may be received from the customer via the portable customer device 300. For example, the customer may select, type-in, or otherwise enter a message (e.g., by speaking the message into a microphone). The controller 400 may then arrange for the message to be delivered, for example, to an employee (e.g., a manager) or another customer (e.g., via a portable customer device 300 associated with the other customer).

According to another embodiment, a message may be provided to the customer via the portable customer device 300. For example, the portable customer device 300 may output a sound and display a table number that will now be associated with the customer (e.g., “Thank you for your patience. Please have a seat at table 19 in the main dining area.”).

Note that a plurality of portable customer devices 300 may be associated with a single location. For example, each person sitting at a table may request or be provided with his or her own portable customer device 300. Similarly, a plurality of customers may be associated with a single portable customer device 300.

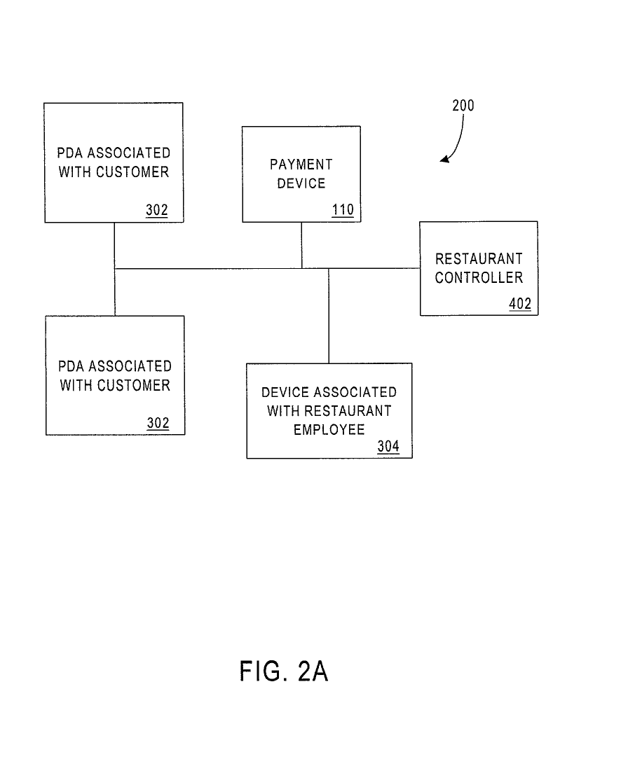

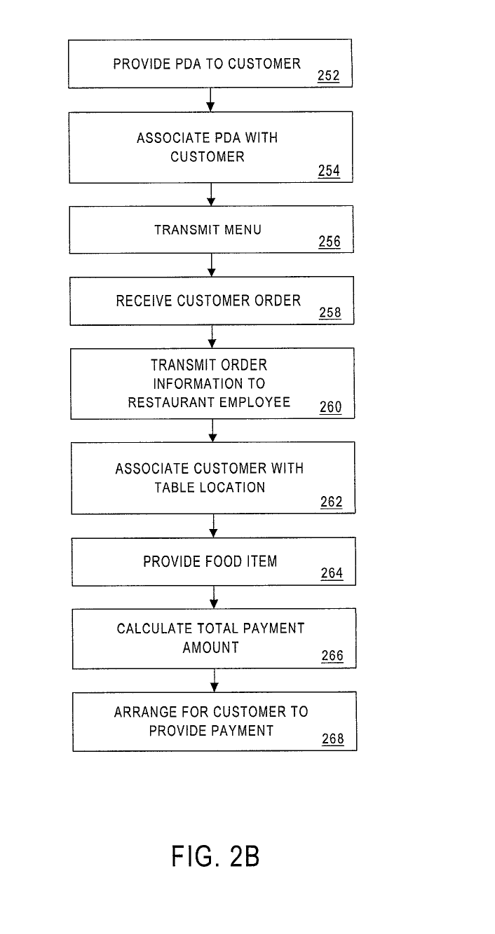

Consider now FIG. 2A, which is a block diagram of a restaurant transaction system 200 according to another embodiment of the present invention. The restaurant transaction system 200 includes a restaurant controller 402 in communication with a number of PDAs 302, each PDA being associated with a customer. According to this embodiment, a customer may use a PDA 302 to receive menu information from, and provide order information to, the restaurant controller 402.

As shown in FIG. 2A, the restaurant controller 402 may also communicate with a device associated with a restaurant employee 304. For example, the restaurant controller 402 may communicate with a host (e.g., an employee who greets and/or seats customers), a waitperson, a manager, a bartender, and/or a chef or other kitchen employee. In this way, the restaurant controller 402 may arrange for a food item to be prepared and/or provided to the customer.

According to one embodiment, the restaurant controller 402 also arranges for the customer to provide a payment in exchange for one or more food items. According to such an embodiment, a payment device 110 may be used to arrange for the customer to provide a payment. For example, the restaurant controller 402 may arrange for a customer to purchase an entree via the payment device 110 (e.g., via a credit card account, a debit card account, a banking account, or an electronic payment protocol). The payment device 110 may also comprise, for example, a third party device (e.g., a credit card processing device), a Credit Authorization Terminal (CAT) device, or a printer (e.g., a printer used to generate a bill and/or a receipt).

FIG. 2B is a flow chart of a computer-implemented method for facilitating restaurant transactions via the restaurant transaction system 200 according to an embodiment of the present invention. At 252, a PDA is provided to a customer. For example, a PDA may be provided to a customer when he or she enters a restaurant. At 254, the PDA is associated with the customer. For example, the controller 400 may store a device identifier in association with a customer identifier. According to another embodiment, the PDA is “associated” with the customer merely by having the customer possess the PDA. That is, the controller 400 may simply arrange for a food item to be delivered wherever the PDA is currently located (which will, naturally, be where the customer is located if he or she currently possesses the PDA).

A menu, such as a dynamically generated menu, is transmitted to the PDA at 256. For example, the controller 400 may generate a menu based on current inventory information and arrange for the menu to be displayed to the customer via the PDA. According to another embodiment, the controller 400 instead retrieves a pre-stored menu (e.g., all customers may receive the same menu).

At 258, a customer order is received from the PDA. The customer order may comprise, for example, a list of food items selected from the menu. Based on the customer order, order information is transmitted to at least one restaurant employee at 260. For example, the controller 400 may instruct a kitchen employee to prepare a particular entrée to be delivered to a customer. According to other embodiments, order information may be transmitted to a host, a waitperson, and/or a manager. Note that this may be performed before the customer is associated with a table location.

At 262, the customer is associated with a table location. For example, a host may seat the customer at a particular table. According to one embodiment, the process described with respect to FIG. 2B instead begins at this point (e.g., the process may be triggered when a customer is seated at a table). The selected food items are then provided to the customer at that table location at 264. For example, the controller 400 may instruct a waitperson to deliver the selected food items to that table location.

A total payment amount is calculated at 266 based on the selected (or provided) food items. For example, the controller 400 may add item prices associated with each ordered food item to determine a total payment amount. Other amounts, such as any applicable tax and/or tip amount, may also be included in the total payment amount.

It is then arranged for the customer to provide payment of the total payment amount at 268. For example, the controller 400 may use payment information associated with the customer (e.g., a credit card number, smart card information, and/or a digital payment protocol) to arrange for the customer to provide the payment. According to other embodiments, arranging for the customer to provide payment may also comprise transmitting check information to the PDA (e.g., to allow the customer to review the information), printing a check (e.g., by transmitting information to a check printing device), transmitting receipt information to the PDA, printing receipt information, processing a payment identifier associated with the customer, and/or receiving tip information from the PDA.

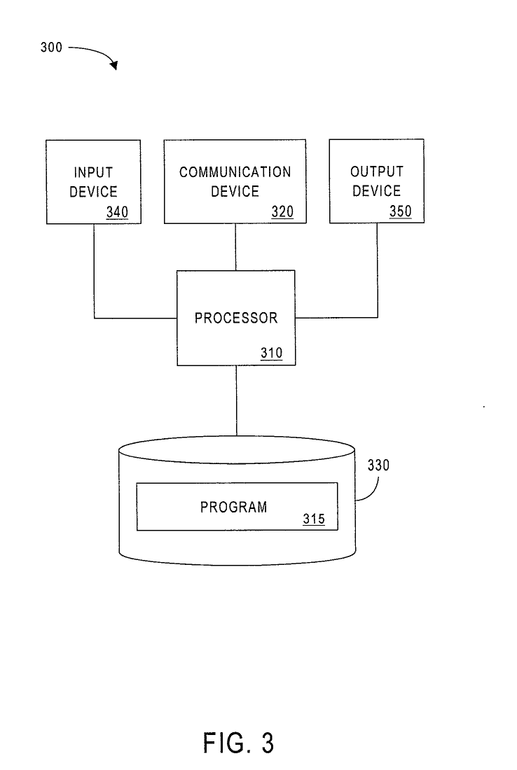

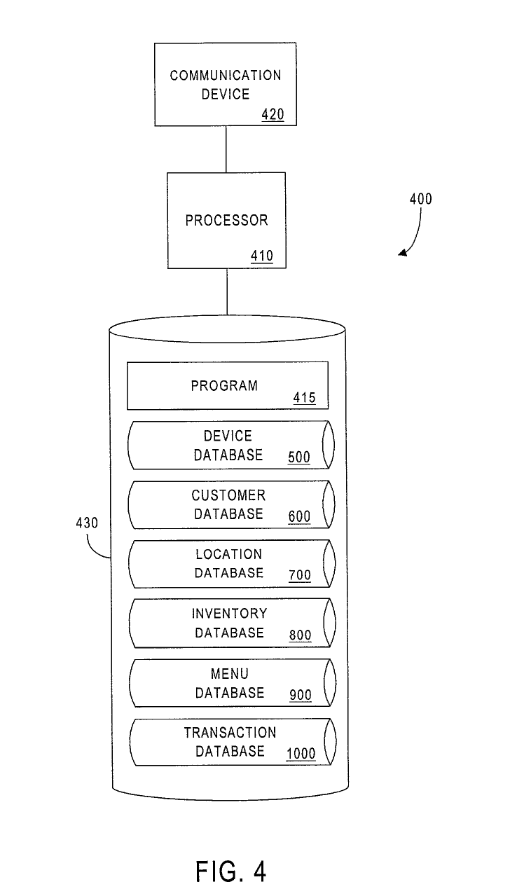

Examples of devices that may be used, for example, in connection with the transaction system 100 and/or the restaurant transaction system 200 will now be described with respect to FIGS. 3 and 4.

### Portable Customer Device

FIG. 3 illustrates a portable customer device 300 that is descriptive of the device shown in FIG. 1A according to an embodiment of the present invention. The portable customer device 300 comprises a processor 310, such as one or more INTEL® Pentium® processors, coupled to a communication device 320 configured to communicate via a communication network (not shown in FIG. 3). The communication device 320 may be used to communicate, for example, with the controller 400, a device associated with an employee, a printer, and/or a payment device.

The processor 310 is also in communication with an input device 340. The input device 340 may comprise, for example, a keyboard, a mouse or other pointing device, a microphone, a knob or a switch (including an electronic representation of a knob or a switch), an infrared port, a docking station, and/or a touch screen (e.g., activated by a customer's finger or by a stylus). Such an input device 340 may be used, for example, by a customer when placing an order. According to one embodiment, the input device 340 comprises a credit card input device used for swiping, validating, and/or authorizing credit cards for settlement of purchases.

The processor 310 is also in communication with an output device 350. The output device 340 may comprise, for example, a display (e.g., a PDA screen), a speaker, and/or a printer (e.g., used to print receipts). The output device 350 may be used, for example, to provide menu and receipt information to a customer.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 stores a program 315 for controlling the processor 310. The processor 310 performs instructions of the program 315, and thereby operates in accordance with the present invention. For example, the processor 310 may arrange for menu information to be displayed to a customer and/or for order information to be received from the customer.

As used herein, information may be “received” by or “transmitted” to, for example: (i) the portable customer device 300 from the controller 400; or (ii) a software application or module within the portable customer device 300 from another software application, module, or any other source.

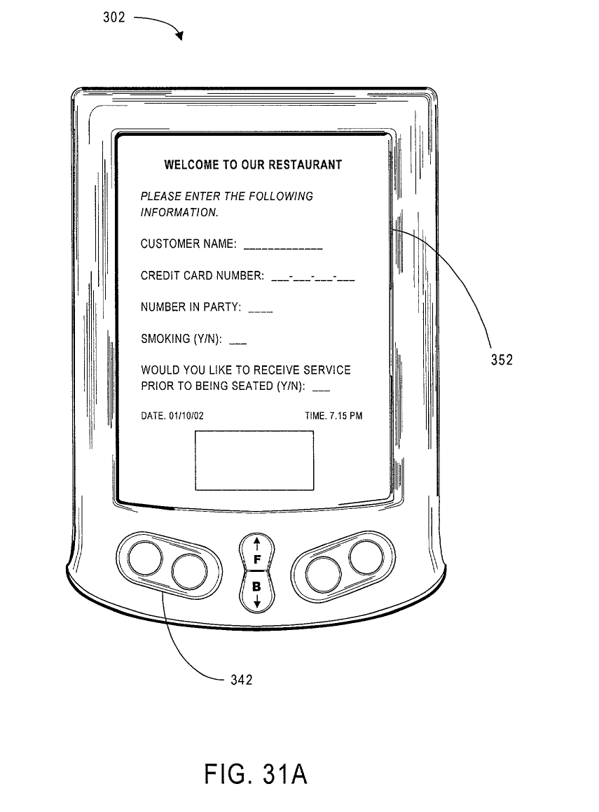

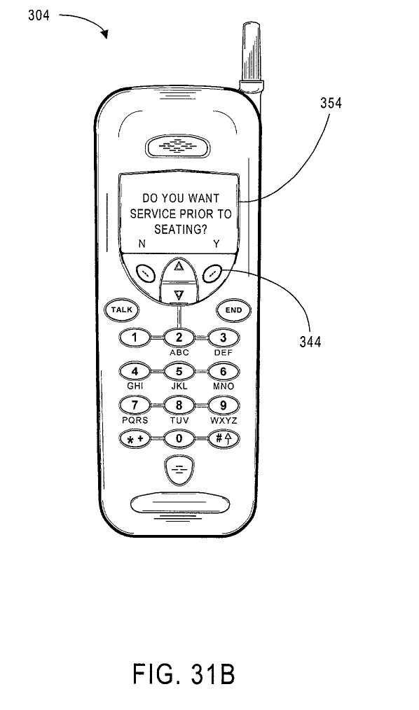

FIG. 31A illustrates a PDA 302 displaying information according to an embodiment of the present invention. The PDA 302 includes a keypad input 342 and a microphone (not shown in FIG. 31A) which can be used by a customer to provide order information. The PDA 302 also includes a display screen 352 and a speaker (not shown in FIG. 31A) which can be used, for example, to provide menu information to a customer.

FIG. 31B illustrates a wireless telephone 304 displaying information according to another embodiment of the present invention. The wireless telephone 304 includes an input device 344 and an output device 354 (e.g., a display screen and/or a speaker) that may be used by a customer as described herein.

### Controller

FIG. 4 illustrates a controller 400 that is descriptive of the device shown in FIG. 1A according to an embodiment of the present invention. The controller 400 comprises a processor 410, such as one or more INTEL® Pentium® processors, coupled to a communication device 420 configured to communicate via a communication network (not shown in FIG. 4). The communication device 420 may be used to communicate, for example, with one or more portable customer devices 300, a device associated with an employee, and/or a payment device.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as RAM devices and ROM devices.

The storage device 430 stores a program 415 for controlling the processor 410. The processor 410 performs instructions of the program 415, and thereby operates in accordance with the present invention. For example, the processor 410 may associate a portable customer device 300 with a customer. The processor 410 may also receive order information from the customer via the portable customer device 300 and arrange for an item to be provided to the customer in response to the order information.

According to another embodiment, the processor 410 arranges for a PDA to be provided to, and associated with, a customer. The processor 410 also dynamically generates and transmits a menu to the PDA and receives a customer order, including a list of food items. Based on the customer order, the processor 410 transmits order information to at least one restaurant employee. The processor 410 also associates the customer with a table location and arranges for the selected food items to be provided to the customer, at that table location, in response to the order information. Finally, the processor 410 calculates a total payment amount based on the selected food items and arranges for the customer to provide payment of the total payment amount.

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the controller 400 from the portable customer device 300; or (ii) a software application or module within the controller 400 from another software application, module, or any other source.

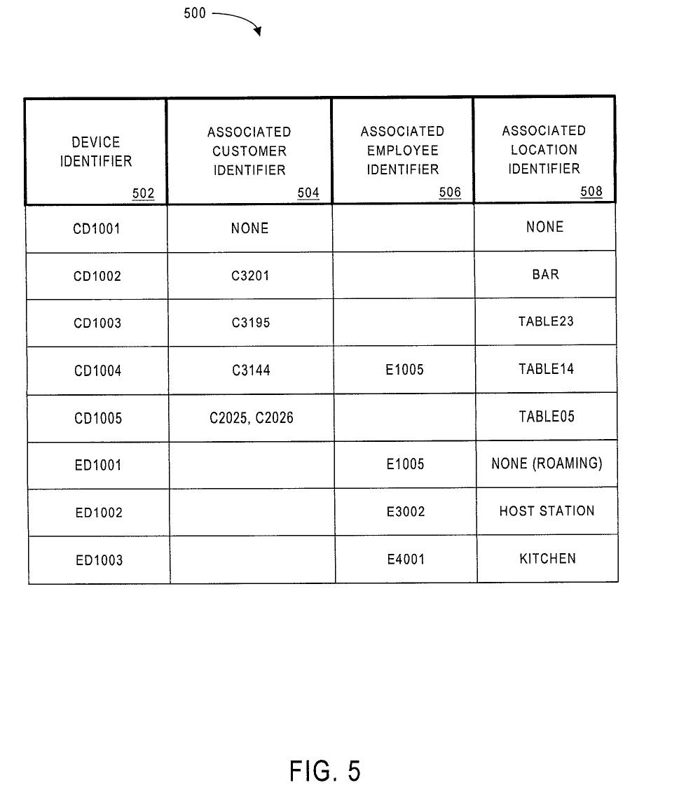

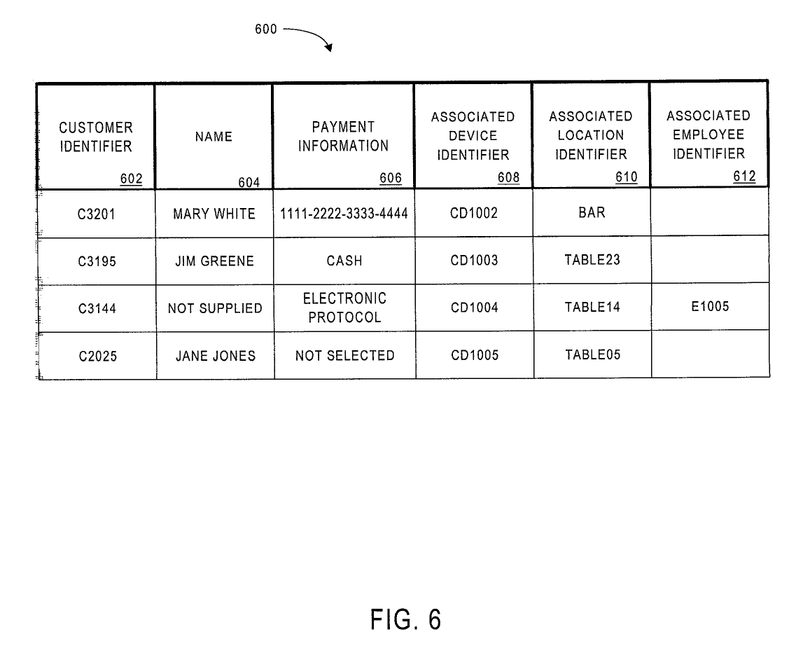

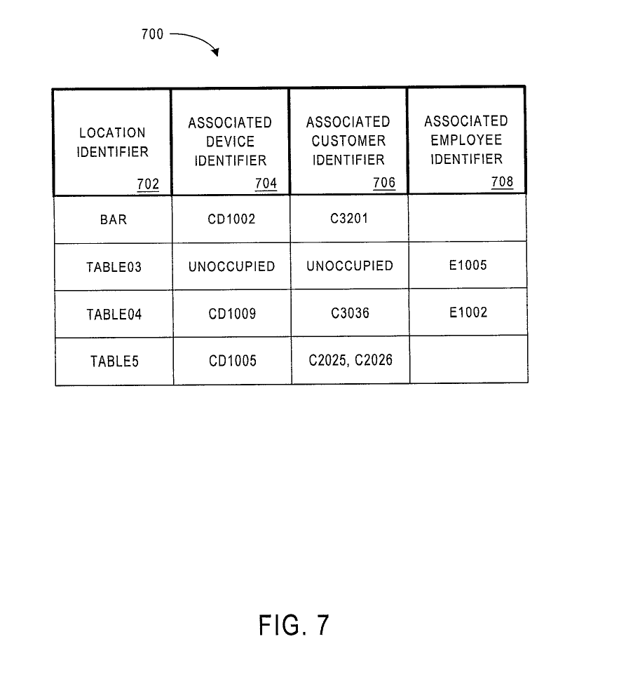

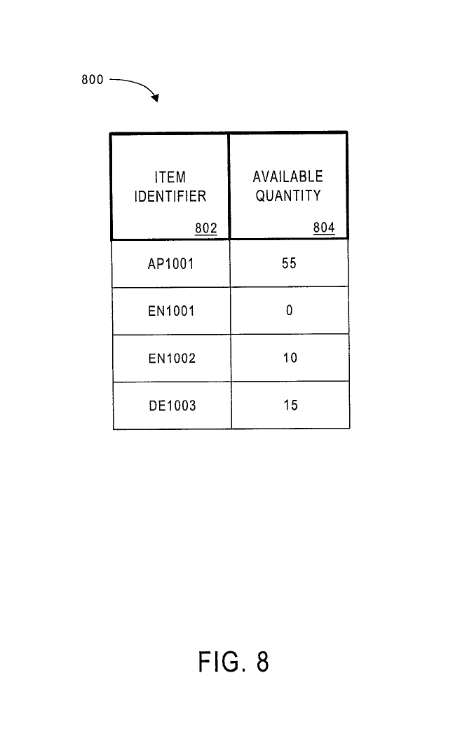

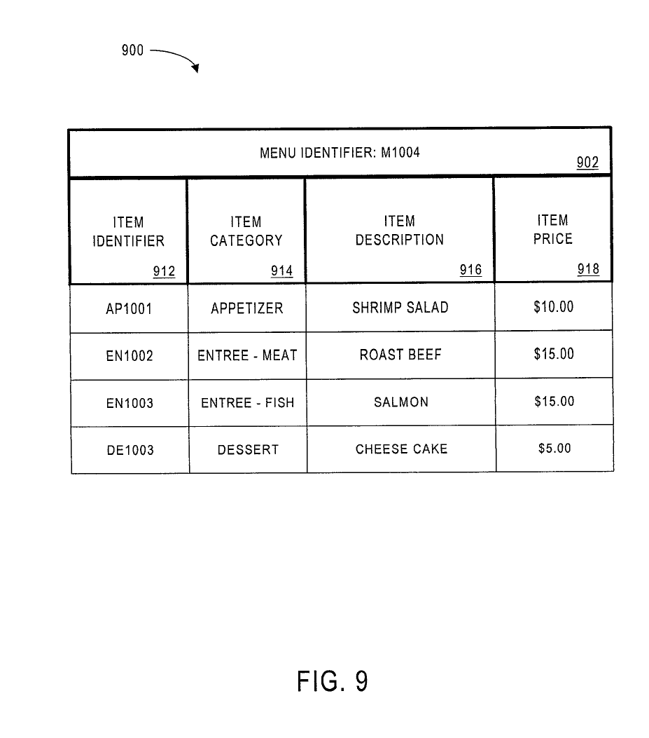

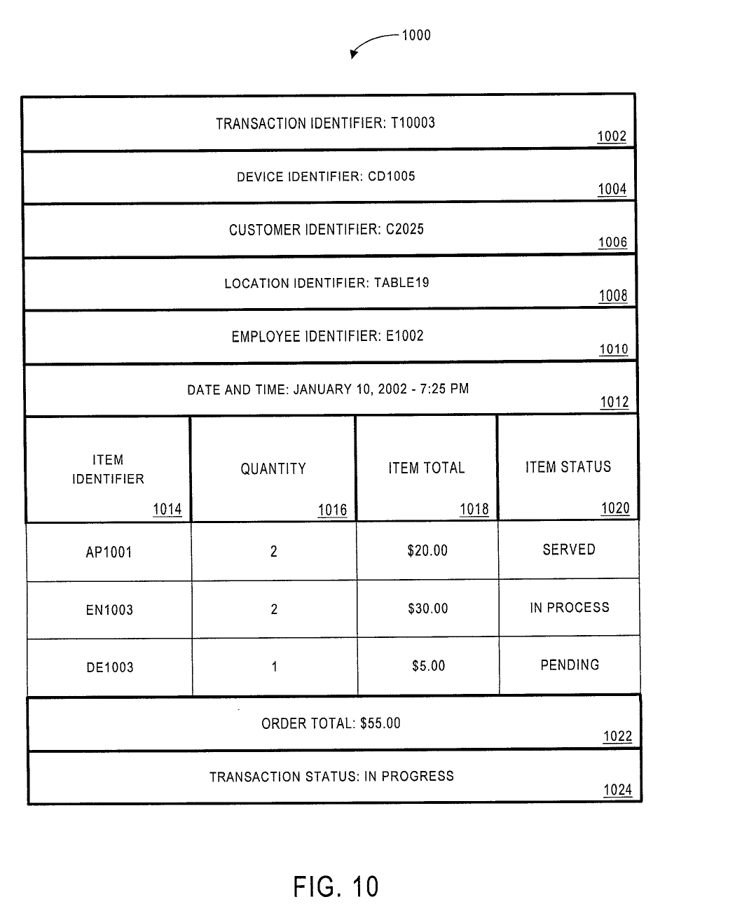

As shown in FIG. 4, the storage device 430 also stores a device database 500 (described with respect to FIG. 5), a customer database 600 (described with respect to FIG. 6), a location database 700 (described with respect to FIG. 7), an inventory database 800 (described with respect to FIG. 8), a menu database 900 (described with respect to FIG. 9), and a transaction database 1000 (described with respect to FIG. 10). Note that the storage device 430 may also store other information, such as an employee database and/or a message database (not shown in FIG. 4). For example, an employee database and/or a message database may store messages to be displayed to employees (e.g., a messages from a manager).

Examples of databases that may be used in connection with the transaction system 100 will now be described in detail with respect to FIGS. 5 through 10. The illustrations and accompanying descriptions of the databases presented herein are exemplary, and any number of other database arrangements could be employed besides those suggested by the figures.

### Device Database

Referring to FIG. 5, a table represents the device database 500 that may be stored at the controller 400 according to an embodiment of the present invention. The table includes entries identifying devices, such as portable customer devices 300 and employee devices, that may be used in connection with the transaction system 100. The table also defines fields 502, 504, 506, 508 for each of the entries. The fields specify: a device identifier 502, an associated customer identifier 504, an associated employee identifier 506, and an associated location identifier 508. The information in the device database 500 may be created and updated, for example, based on information received from an employee (e.g., a restaurant manager), a device, and/or a customer.

The device identifier 502 may be, for example, an alphanumeric code associated with a device that is provided to and/or associated with a customer or employee. For example, the device identifier 502 may represent a serial number associated with a PDA or a registration number associated with a particular software program. According to one embodiment, the device identifier 502 is also displayed via the device (e.g., the device identifier 502 may be displayed on a PDA screen or may be printed on the PDA itself). In this way, a customer or employee can easily determine the device identifier 502 associated with a particular device.

The associated customer identifier 504 represents a customer that is associated with the device. For example, an associated customer identifier 504 of “none” may indicate that a particular device is not currently associated with a customer (e.g., the device may be located at a host station to be provided to a future customer when he or she arrives). Note that, according to one embodiment, multiple customers may be associated with a single device.

The associated employee identifier 506 represents an employee that is associated with the device. The associated employee identifier 506 may indicate, for example, that the device is being used by an employee (e.g., the device has been “checked-out” to a waitperson for use during his or her shift). The associated employee identifier 506 may instead indicate, for example, that a particular employee has been assigned to serve a customer associated with the device.

The associated location identifier 508 represents a location that is associated with the device. For example, the associated location identifier 508 may indicate that a device is associated with a particular table, an area in a restaurant (e.g., a bar or waiting area), or an employee location (e.g., the kitchen).

### Customer Database

Referring to FIG. 6, a table represents the customer database 600 that may be stored at the controller 400 according to an embodiment of the present invention. The table includes entries identifying customers who may purchase items via the transaction system 100. The table also defines fields 602, 604, 606, 608, 610, 612 for each of the entries. The fields specify: a customer identifier 602, a name 604, payment information 606, an associated device identifier 608, an associated location identifier 610, and an associated employee identifier 612. The information in the customer database 600 may be created and updated, for example, based on information received from a customer when he or she arrives at a restaurant. The information in the customer database 600 may also be based on, for example, information generated as the customer exchanges information via the transaction system 100.

The customer identifier 602 may be, for example, an alphanumeric code associated with a customer who has registered to use the transaction system 100. The customer identifier 602 may be generated by, for example, the controller 400 or the customer (e.g., when the customer provides a user name). The customer database 600 also stores the name 604 and payment information 606 (e.g., a credit card, debit card or bank account number or digital payment protocol information) associated with each customer. The payment identifier 606 may be used, for example, by the controller 400 to secure a portable customer device and/or to arrange for the customer to provide a payment in exchange for foods items.

The associated device identifier 608 represents a device that is associated with the customer and may be based on, or associated with, the device identifier 502 stored in the device database 500.

The associated location identifier 610 represents a location that is associated with the customer. For example, the associated location identifier 508 may indicate that a customer is associated with a particular table or an area in a restaurant (e.g., a bar or waiting area).

The associated employee identifier 612 represents an employee that is associated with the customer. The associated employee identifier 612 may indicate, for example, that a particular employee has been assigned to serve that customer.

### Location Database

Referring to FIG. 7, a table represents the location database 700 that may be stored at the controller 400 according to an embodiment of the present invention. The table includes entries identifying locations that may be associated with a device and/or a customer. The table also defines fields 702, 704, 706, 708 for each of the entries. The fields specify: a location identifier 702, an associated device identifier 704, an associated customer identifier 706, and an associated employee identifier 708. The information in the location database 700 may be created and updated, for example, based on information received from a customer, a device, and/or an employee.

The location identifier 702 may be, for example, an alphanumeric code associated with a particular table or area in a restaurant. For example, the location identifier 702 may represent a bar or waiting area.

The associated device identifier 704 represents a device that is associated with the location and may be based on, or associated with, the device identifier 502 stored in the device database 500.

The associated customer identifier 706 represents a customer that is associated with the location and may be based on, or associated with, the customer identifier 602 stored in the customer database 600. For example, the associated customer identifier 706 may indicate that a location is “unoccupied” or that one or more customers are associated with that location.

The associated employee identifier 708 represents an employee that is associated with the location. The associated employee identifier 708 may indicate, for example, that a particular employee has been assigned to serve that location (e.g., even when no customer is currently assigned to that location).

### Inventory Database

Referring to FIG. 8, a table represents the inventory database 800 that may be stored at the controller 400 according to an embodiment of the present invention. The table includes entries identifying items that may be purchased via the transaction system 100. The table also defines an item identifier 802 and an available quantity 804 for each of the entries. The information in the inventory database 800 may be created and updated, for example, based on information received from an automated inventory system, information received from an employee, and/or order information received from a portable customer device 300.

The item identifier 802 may be, for example, an alphanumeric code associated with an item that may be purchased via the transaction system 100. For example, the item identifier 802 may represent an appetizer that can be purchased by a customer. According to another embodiment, the item identifier 802 is instead associated with, for example, an ingredient associated with an item that may be purchased.

The available quantity 804 indicates an amount of an item that is available to be purchased. For example, the available quantity 804 may indicate that there are “0” units of an item available to be purchased. In this case, the item may be omitted from a menu that is displayed to a customer. According to another embodiment, the available quantity 804 is used to determine an item price associated with an item (e.g., an item price may be increased when the available quantity falls below a predetermined threshold value).

### Menu Database

Referring to FIG. 9, a table represents a record in the menu database 900 that may be stored at the controller 400 according to an embodiment of the present invention. The database includes records associated with menus that may be displayed to customers via the transaction system 100. As shown in FIG. 9, each record includes a menu identifier 902 associated with a menu. The menu identifier 902 may be, for example, an alphanumeric code associated with a particular time of day, a particular customer, and/or a type of customer (e.g., a children's menu).

The table also defines fields 912, 914, 916, 918 for each record. The fields specify: an item identifier 912, an item category 914, an item description 916, and an item price 918. The information in the menu database 900 may be created and updated, for example, based on information received from an employee, information received from a customer, and/or information in the inventory database 800. According to one embodiment, the information in the menu database 900 is dynamically generated by the controller 400. According to another embodiment, the controller 400 instead retrieves pre-stored menu information from the menu database 900.

The item identifier 912 indicates an item that may be purchased via the transaction system 100 and may be based on, or associated with, the item identifier 802 stored in the inventory database 800.

The item category 914 indicates a category associated with the item. For example, an item may be considered an “appetizer,” an “entrée,” or a “dessert.” The item category 914 may be used by the controller 400, for example, to dynamically generate a customer menu for a customer (e.g., a menu listing only appetizers).

The item description 916 comprises information describing the item. The item description may comprise, for example, text information (e.g., a description of an item, including ingredients used to prepare the item and nutritional information associated with the item), audio information (e.g., a recorded message describing the item), and/or image information (e.g., a photographic image of an entrée).

The item price 918 indicates an amount a customer will pay in exchange for receiving an item. The item price 918 may be based on, for example, pre-stored information, information associated with a customer, and/or information stored in the inventory database 800.

According to another embodiment, the menu database 900 is stored at the portable customer device 300. That is, each portable customer device 300 may store one or more standard menus. In this case, any change to a menu may require that the menu be restored on each portable customer device 300.

### Transaction Database

Referring to FIG. 10, a table represents a record in the transaction database 1000 that may be stored at the controller 400 according to an embodiment of the present invention. The database includes records associated with transactions performed via the transaction system 100. As shown in FIG. 10, each record includes a transaction identifier 1002 associated with a transaction. The transaction identifier 1002 may be, for example, an alphanumeric code associated with a particular transaction.

Each record in the transaction database 1000 also indicates a device identifier 1004, a customer identifier 1006, and a location identifier 1008 associated with the transaction. This information may be, for example, based on or associated with the device identifier 502 stored in the device database 500, the customer identifier 602 stored in the customer database 600, and the location identifier 702 stored in the location database 700, respectively.

Each record also indicates an employee identifier 1010 and a date and time 1012 associated with the transaction (e.g., indicating when a transaction was started or completed).

The table also defines fields 1014, 1016, 1018, 1020 for each record. The fields specify: an item identifier 1014, a quantity 1016, an item total 1018, and an item status 1020. Each item identifier 1014 indicates an item that was purchased in the transaction, and the quantity 1016 indicates how may of those items were purchased. The item total 1018 may then be calculated, for example, by multiplying the appropriate item price 918 stored in the menu database 900 by the quantity 1016.

The item status 1020 may indicate, for example, if an item is “pending” (e.g., the kitchen has not yet started to prepare the item), “in process” (e.g., the item is being prepared in the kitchen), or has been “served” to the customer. The item status 1020 may be used to determine, for examine, if a customer will be allowed to change an order after it has been submitted to the controller 400 (e.g., only items that are “pending” may be changed).

Each record also indicates an order total 1022 associated with the transaction. The order total 1022 may represent, for example, the sum of each item total 1018. The order total 1022 may also include, for example, an applicable tax and/or tip amount associated with the transaction. Finally, each record indicates an overall transaction status 1024. The transaction status 1024 may indicate, for example, whether a transaction is “in progress” or has been “completed.”

### Detailed Restaurant Transaction System

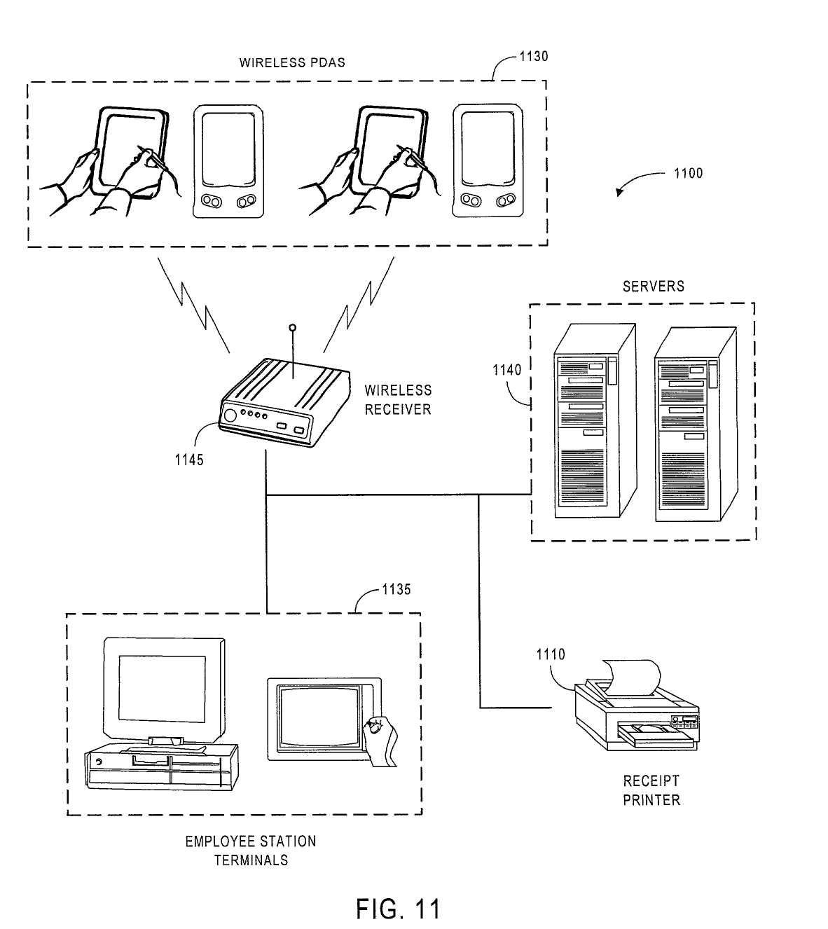

FIG. 11 is a detailed diagram of a restaurant transaction system 1100 according to one embodiment of the present invention. The restaurant transaction system 1100 includes one or more restaurant servers 1140 that communicate with a number of wireless PDAs 1130 via a wireless receiver 1145. One or more of the devices shown in FIG. 11 may also communicate, for example, with a wireless printer. According to one embodiment, the restaurant servers 1140 are adapted to communicate via a wired/wireless Ethernet communication system. For example, the restaurant servers 1140 may communicate via an 802.11b network (wireless), a Bluetooth network, and/or a 10/100 10 based T type network (wired).

The restaurant servers 1140 may include, for example, a dedicated restaurant controller and a Web server.

The dedicated restaurant controller may, for example, build both static and dynamic pages. The static pages may be designed to provide pages that are not intended to frequently change (e.g., a wine list). Note that some static pages may have one or more dynamic components (e.g., a standard list of menu items with dynamically determined item prices).

The Web server may comprise, for example, a COMPAQ® Web server executing APACHE® server software. Firewall protection may also be provided to prevent unauthorized access to the restaurant transaction system 1100.

Each wireless PDA 1130 may be associated with, for example, a customer or a restaurant employee. By way of example, the wireless PDA 1130 may be a PALM® or HANDSPRING® device executing the PALM® Operating System (OS) or a POCKET PC® running Microsoft's® WIN CE® OS. According to one embodiment, a wireless PDA 1130 acts as a thin client running a Web browser application used to access menu and music information on the restaurant servers 1140. A wireless PDA 1130 may include, for example, a wireless LAN card running the 802.11b protocol and may execute a standard non-Wireless Application Protocol (WAP) browser client that accesses the Web server.

According to one embodiment, the bottom and sides of each wireless PDA 1130 are covered by a rubberized case. The rubberized case may, for example, protect the wireless PDA 1130 in a restaurant environment.

The restaurant servers 1140 also communicate with a number of employee station terminals 1135. An employee station terminal 1135 may be located, for example, at the restaurant's host station, at a salad area, behind a bar, and/or in a kitchen or food preparation area. The employee station terminals 1135 will enable employees to interact with the restaurant transaction system 1100. Each employee station terminal 1135 may include, for example, a touch screen. Order information may be sent from the restaurant servers 1140 to the employee station terminals 1135 where employees can receive and acknowledge orders and/or transmit queries to the restaurant servers 1140. According to another embodiment, some or all of these functions are instead performed by wireless PDAs 1130 associated with employees.

Finally, the restaurant servers 1140 communicate with a receipt printer 1110 that may be used to generate a check or receipt for a customer. Note that the receipt printer 1110 may be coupled to or otherwise associated with an employee station terminal 1135 and or a portable customer device such as the wireless PDA 1130.

According to an embodiment of the present invention, a customer is associated a wireless PDA 1130, and the customer uses the wireless PDA 1130 to communicate with the restaurant servers 1140. For example, the customer may use the wireless PDA 1130 to access a Web site associated with the restaurant servers 1140 to (i) receive menu information and (ii) place a food order. In this case, the restaurant servers 1140 may instruct employees to prepare and deliver the food order via the employee station terminals 1135 (and/or a wireless PDA 1130 associated with an employee) and generate a receipt for the customer using the receipt printer 1110.

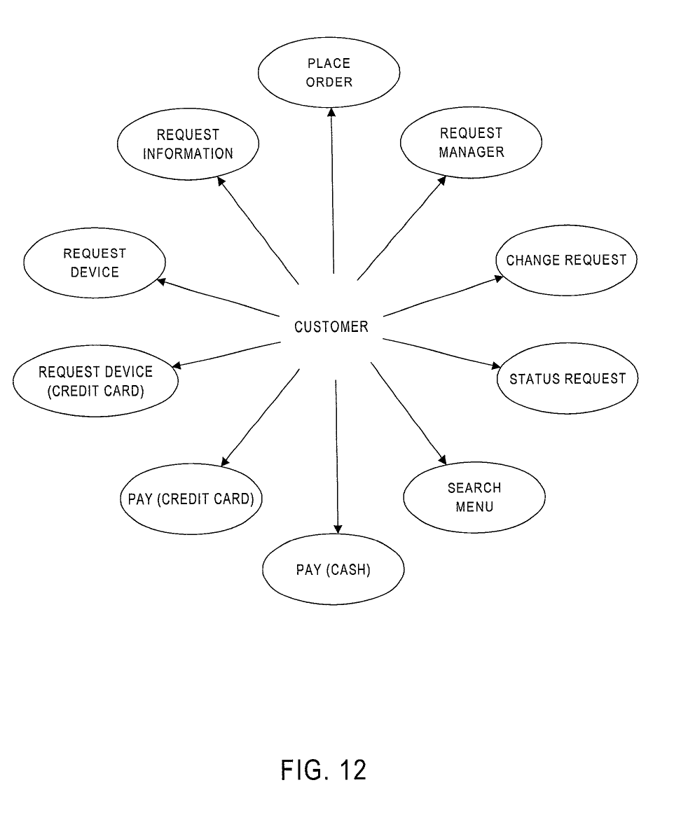

Information flows associated with the restaurant transaction system 1100 will now be described in detail with respect to FIGS. 12 through 30B.

### Customer Information Flow Diagrams—Portable Device Embodiment

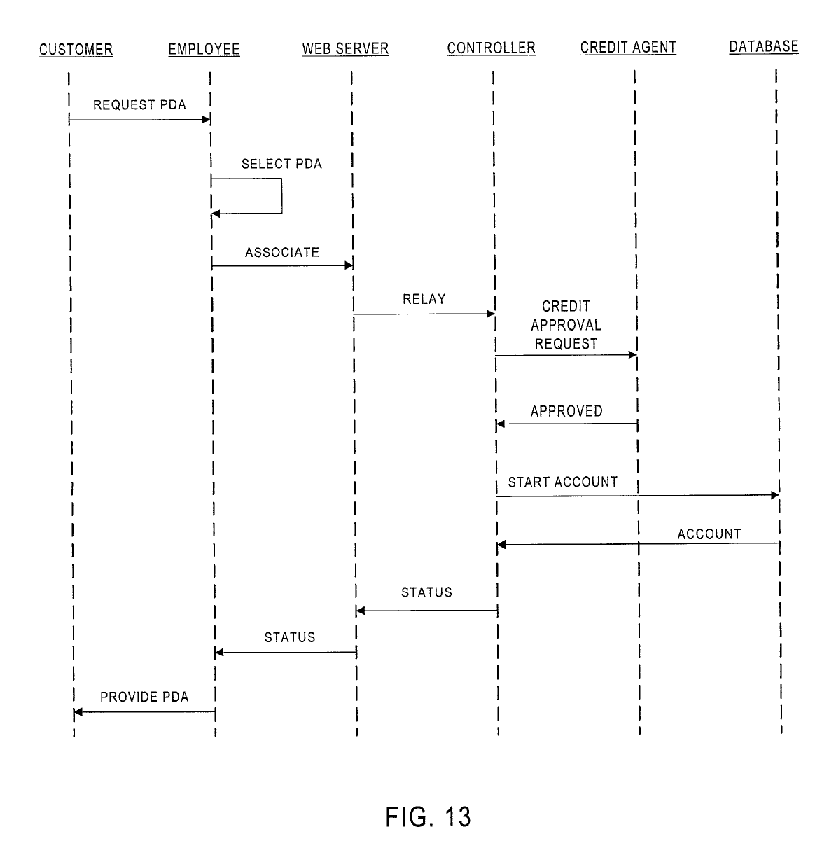

FIG. 12 is a customer state diagram according to an embodiment of the present invention wherein a customer is associated with a wireless PDA 1130. Note that a customer may perform the various functions described in FIG. 12 after requesting a wireless PDA 1130 to use while at the restaurant. As shown in FIG. 12, the customer may: request a device using a credit card, request a device (without using a credit card), request information, place an order, request a manager, change a request, request a status, search a menu, arrange for payment using cash, and/or arrange for payment using a credit card. FIGS. 13 to 21 are customer information flow diagrams according to this embodiment of the present invention.

As shown in FIG. 13, a customer may request a wireless PDA 1130 from a restaurant employee. The employee selects a wireless PDA 1130 and arranges for that wireless PDA 1130 to be associated with the customer. That is, the employee transmits information to the Web server, which in turn relays the information to the controller.

According to this embodiment, the customer provides a credit card to the employee, and the controller communicates with a credit agent and a database to receive a credit approval and to open a Customer Transaction Record (CTR) to track and/or accumulate account activity for the customer (e.g., using the transaction database 1000). After the CTR is opened, information is sent from the controller to the employee via the Web server and the employee provides the wireless PDA 1130 to the customer. Note that, according to one embodiment (not shown in FIG. 13), the wireless PDA 1130 may be provided to a customer even if he or she does not supply a credit card number to the employee.

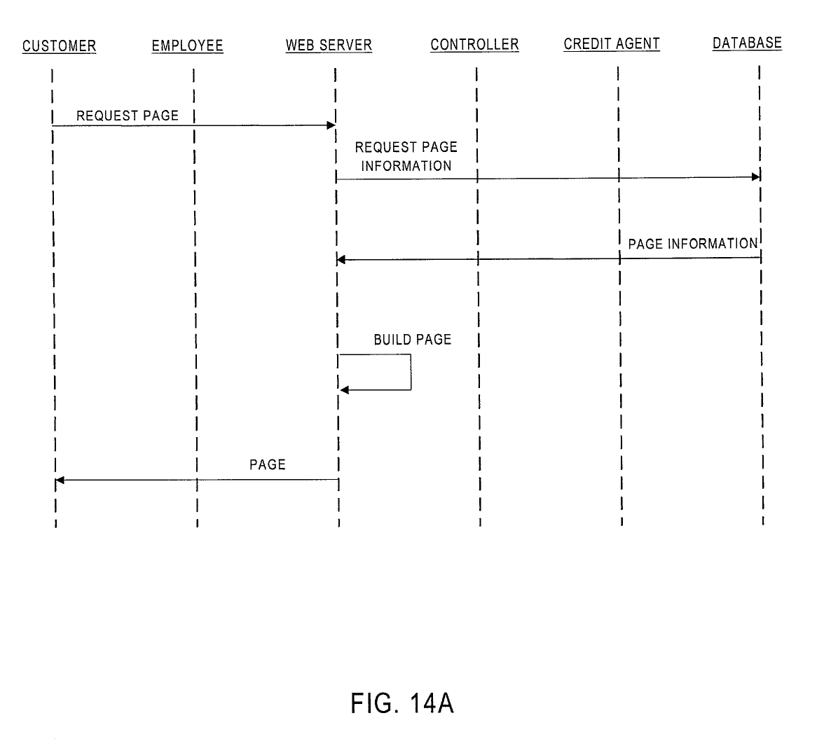

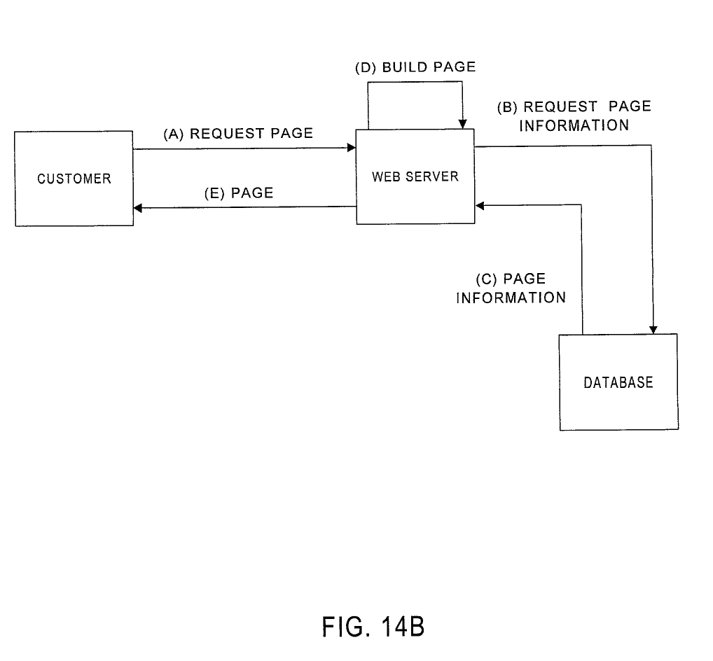

FIG. 14A illustrates an information flow when a customer requests information via the restaurant transaction system 1100. In this case, the customer uses his or her wireless PDA 1130 to transmit information directly to the Web server (e.g., the customer does not need to communicate with an employee). For example, the customer may ask to see a list of menu items, games, or music selections. The customer may do this, for example, by entering the request or by selecting a link on a Web page.

Based on the customer's request, the Web server requests and receives information from a database (e.g., from the menu database 900), builds an appropriate Web page based on the received information, and transmits the Web page to the customer's wireless PDA 1130.

Another view of this process is shown in FIG. 14B. At (A), the customer transmits a request for information to the Web server. The Web server then requests the appropriate page information from a database at (B) and receives the page information at (C). For example, the Web server may receive information from the menu database 900. Based on the received page information, the Web server builds the appropriate page at (D) and transmits the page to the customer at (E).

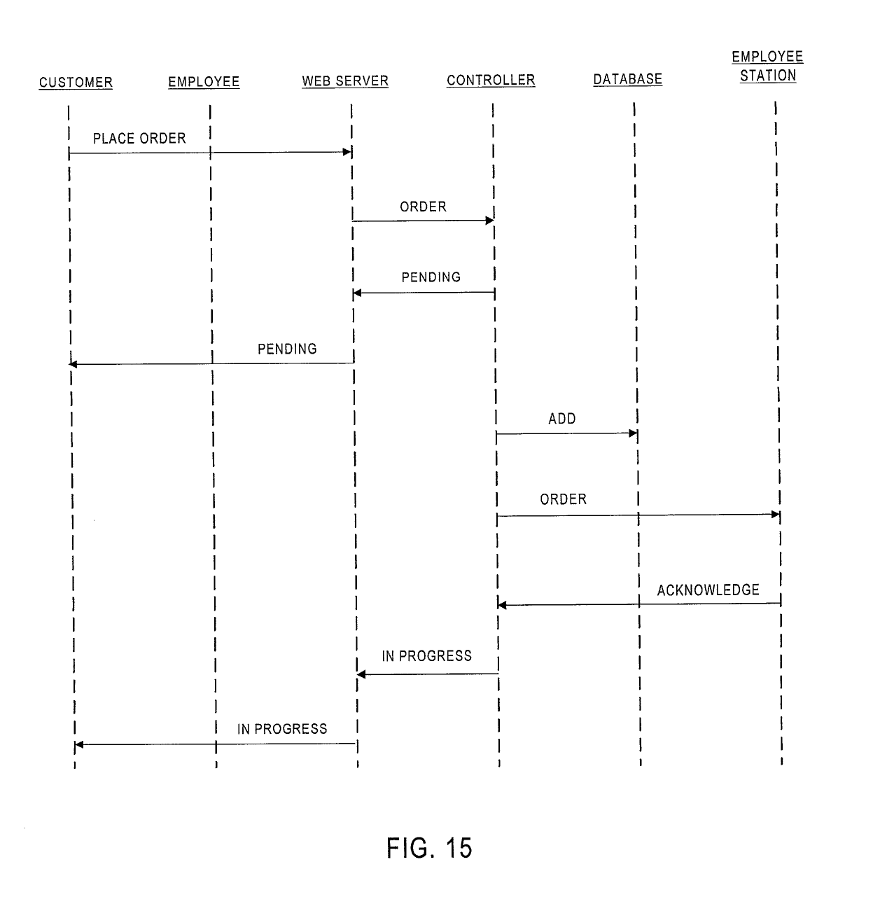

FIG. 15 illustrates an information flow when a customer places an order via the restaurant transaction system 1100. The customer may select items (e.g., soft drinks, bar drinks, appetizers, entrées, and/or desserts) from a menu displayed on his or her wireless PDA 1130. When the customer is finished selecting items, he or she may indicate that the “order is complete.”

The order information may then sent to the controller via the Web server (e.g., without being communicated to an employee such as a waitperson), and the controller may indicate to the customer that the order is now “pending.” The controller may also add the order to a database and transmit information associated with the order to an employee station (e.g., instruction the employee to begin preparing the order). After the employee acknowledges the order to the controller (e.g., by indicating that he or she is now preparing the order), the controller transmits an “in progress” indication to the wireless PDA 1130 via the Web server.

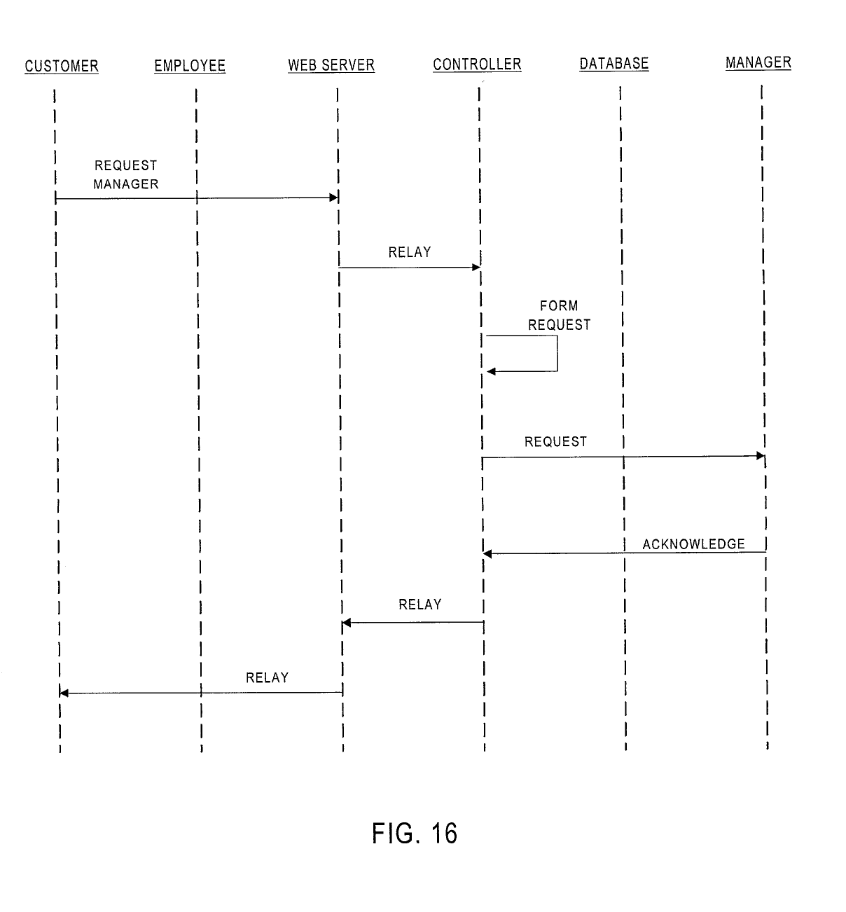

FIG. 16 illustrates an information flow when a customer requests to see or speak with a manager via the restaurant transaction system 1100. For example, there may be a “request manager” link displayed on the customer's wireless PDA 1130. The customer may select the link, and the request may be relayed to the controller via the Web server. The controller may the form a request and forward the request to a manager (e.g., after determining which manager is associated with the customer). When the manager acknowledges the request (e.g., via an employee station terminal 1135), the acknowledgement is relayed to the customer via the controller and the Web server. Note that the customer may interact with the manager in person or via his or her wireless PDA 1130.

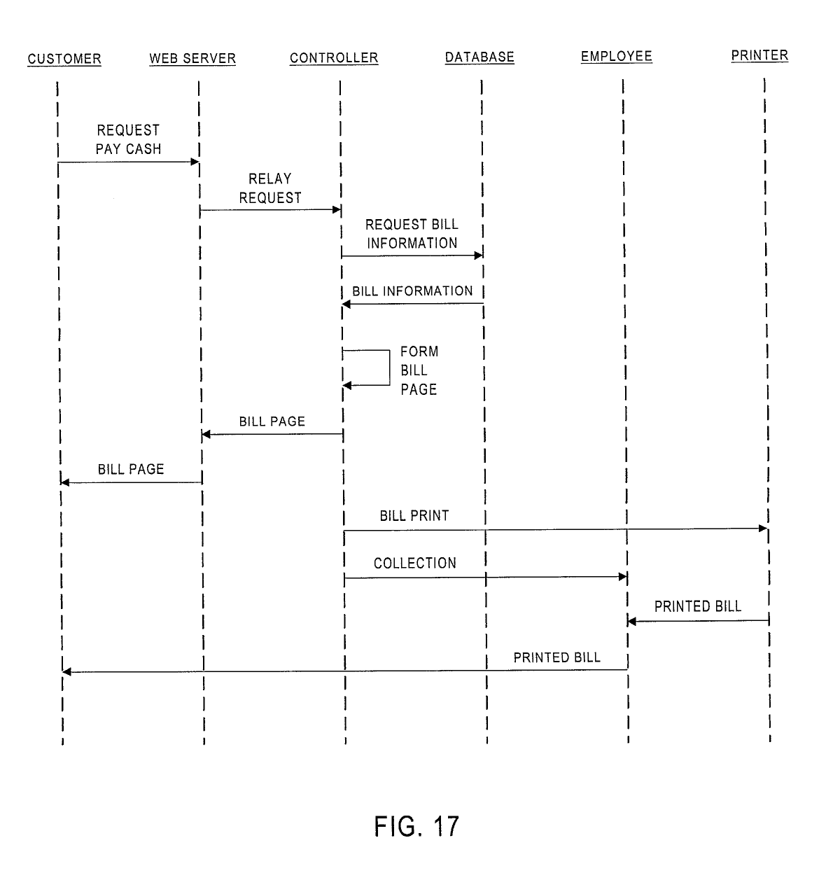

FIG. 17 illustrates an information flow when a customer arranges to provide payment using cash via the restaurant transaction system 1100. When a customer requests to close out his or her current account using cash (e.g., by selecting a link displayed on a wireless PDA 1130), the request is relayed to the controller via the Web server. The controller requests and receives bill information from a database (e.g., from the transaction database 1000) and forms an appropriate bill page for the customer. The bill page is then transmitted to the customer via the Web server. This may allow the customer to review the bill information.

In addition to transmitting the bill page to the customer, the controller directs a printer to generate a printed bill and instructs an employee to collect the printed bill from the printer. The employee then collects the printed bill and delivers it to the customer. The customer may then provide a cash payment to the employee in the traditional manner.

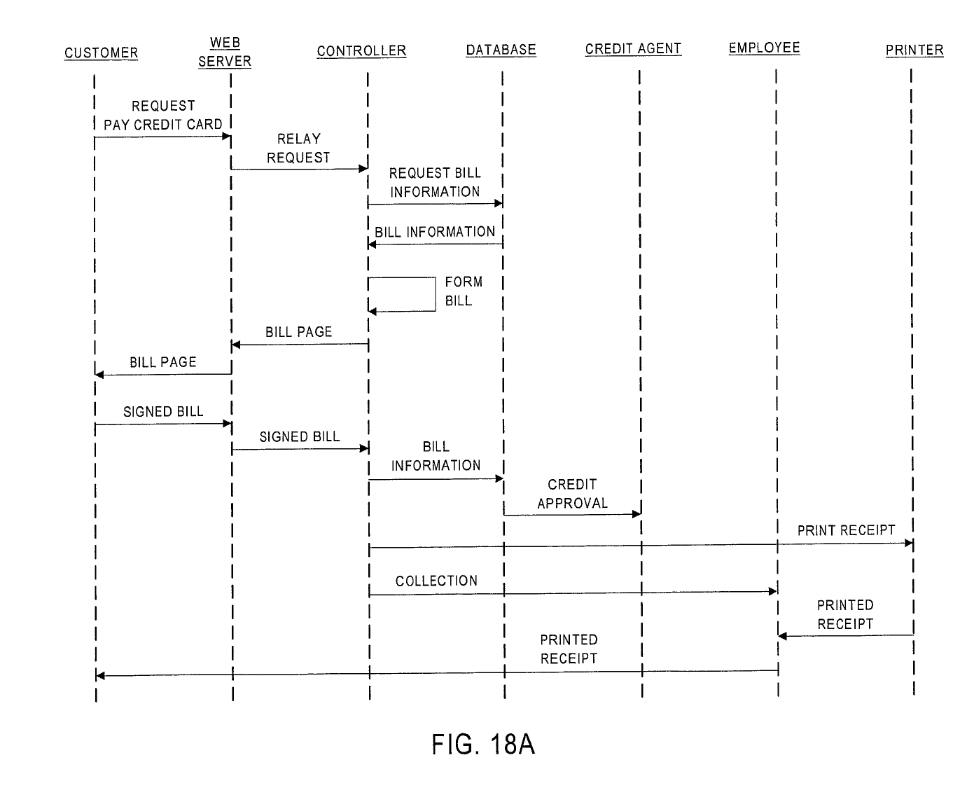

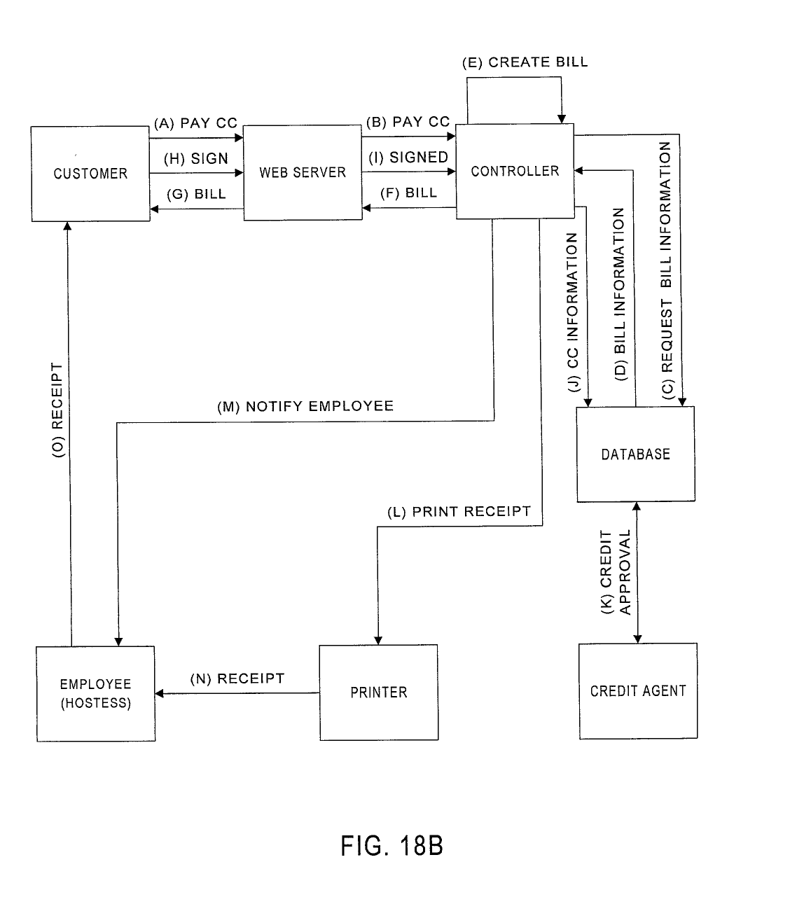

FIG. 18A illustrates an information flow when a customer instead arranges to provide payment using a credit card. When a customer requests to close out his or her current account using a credit card (e.g., by selecting a link displayed on a wireless PDA 1130), the request is relayed to the controller via the Web server. The controller requests and receives bill information from a database (e.g., from the transaction database 1000) and forms an appropriate bill page for the customer. Note that the bill information received by the controller may also include the payment information 606 stored in the customer database 600 (e.g., a credit card number supplied by the customer when he or she received the wireless PDA 1130). The bill page is then transmitted to the customer via the Web server.

The customer may then sign the bill using his or her wireless PDA 1130. The signed bill is relayed to the controller via the Web server, and the controller arranges to receive a credit approval from a credit agent. In addition to arranging credit approval, the controller directs a printer to generate a printed receipt and instructs an employee to collect the printed receipt from the printer. The employee then collects the printed receipt and delivers it to the customer.

Another view of this process is shown in FIG. 18B. At (A), a customer requests to close out his or her current account using a credit card. The request is then relayed to the controller via the Web server at (B). The controller requests and receives bill information from a database at (C) and (D) and creates an appropriate bill page for the customer at (E). At (F) and (G), the bill page is transmitted to the customer via the Web server.

The customer then signs the bill using his or her wireless PDA 1130, and the signed bill is relayed to the controller via the Web server at (H) and (I). At (J) and (K), the controller arranges to receive a credit approval from a credit agent. In addition to arranging credit approval, the controller directs a printer to generate a printed receipt at (L) and notifies an employee to collect the printed receipt from the printer at (M). The employee then collects the printed receipt at (N) and delivers it to the customer at (0).

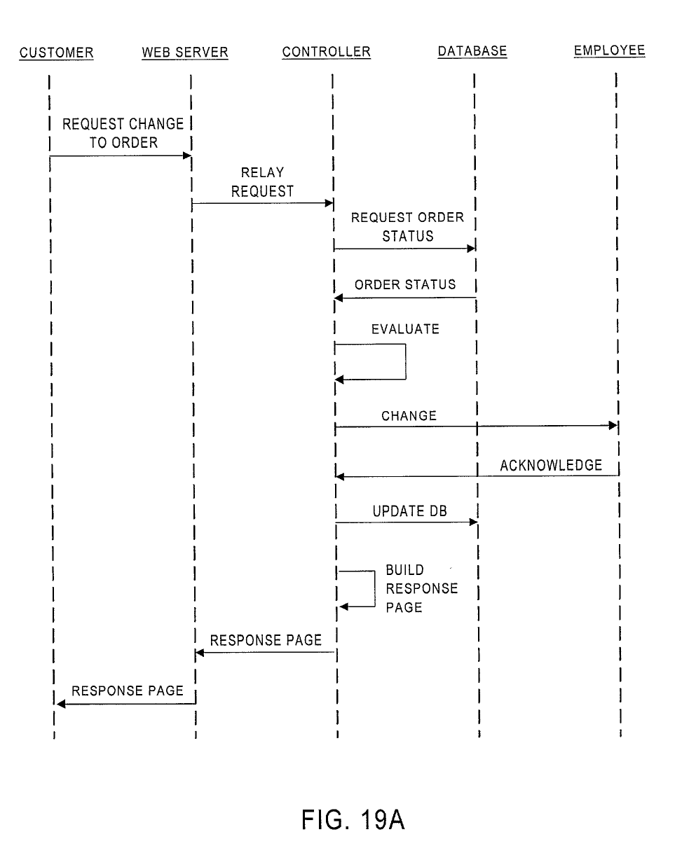

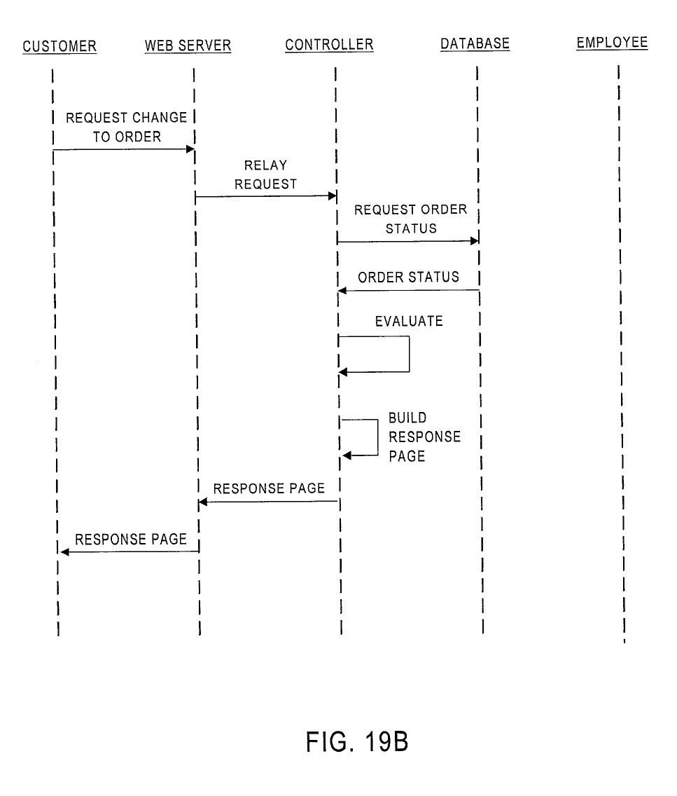

FIG. 19A illustrates an information flow when a customer attempts to change a previously transmitted order via the restaurant transaction system 1100. A request to change the order is transmitted from a wireless PDA 1130 to the controller via the Web server. For example, a customer may ask to cancel a dessert item that he or she had previously ordered. The controller communicates with a database to determine a current status associated with the order, or with the particular item the customer wishes to modify. For example, the controller may receive such information from the transaction database 1000. The controller evaluates the status, and in this case determines that the change will be allowed. For example, if the item status 1020 is “pending” (e.g., no employee has started to prepare the item), the change may be allowed.

The change is transmitted to an employee (e.g., an employee in the kitchen), who acknowledges the change. The database is then updated (e.g., to remove an item from an order), and a response page (e.g., indicating that the change has been approved) is built and relayed to the customer via the Web server.

FIG. 19B illustrates an information flow when a customer is not allowed to change an order. A request to change the order is transmitted from a wireless PDA 1130 to the controller via the Web server. The controller communicates with a database to determine a current status associated with the order, or with a particular item that the customer wishes to modify. The controller evaluates the status, and in this case determines that the change will not be allowed. For example, if the item status 1020 is “in process” (e.g., an employee has already started to prepare the item), the change may not be allowed. The controller then builds a response page (e.g., indicating that the change has not been approved), and the response page is relayed to the customer via the Web server.

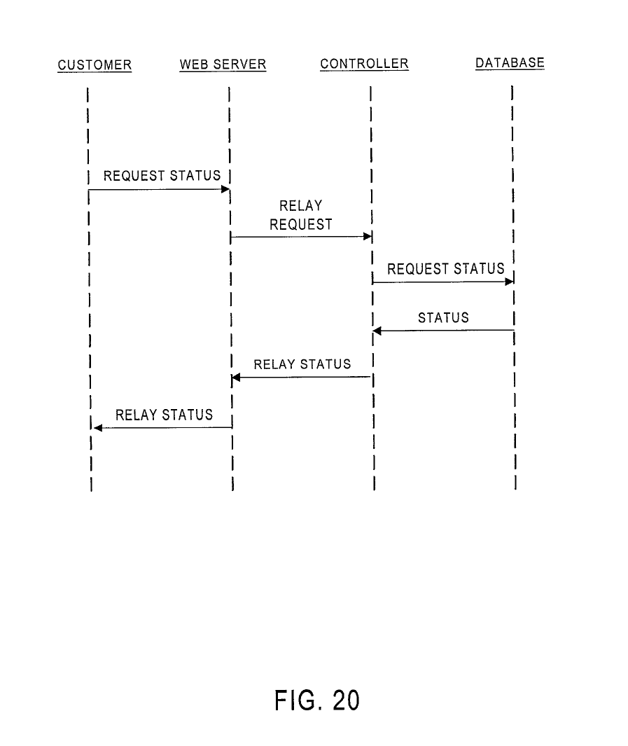

FIG. 20 illustrates an information flow when a customer requests status information via the restaurant transaction system 1100. A request to for an order status is transmitted from a wireless PDA 1130 to the controller via the Web server. For example, a customer may ask to see the status of his or her entrée. The controller communicates with a database to determine a status (e.g., by retrieving the item status 1020 from the transaction database 1000). The status information is then relayed to the customer via the Web server. By way of example, the status information may indicate an elapsed time (e.g., how long ago the customer placed the order), an estimated time of completion, and/or an explanation of any delays associated with the order.

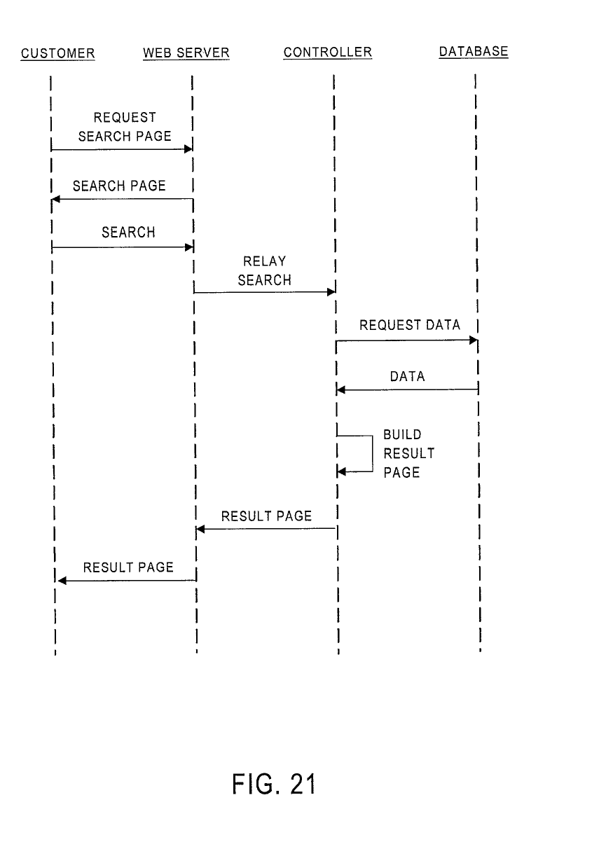

FIG. 21 illustrates an information flow when a customer searches for information via the restaurant transaction system 1100. A request to search for information is transmitted from a wireless PDA 1130 to the Web server. The Web server sends a search page to the customer, who may then use the search page to enter his or her specific request. For example, a customer may search for items based on item ingredients, item prices, previously ordered items, and/or a item's popularity. The specific search request is then transmitted from the wireless PDA 1130 to the controller via the Web server. The controller searches a database based on the customer's search request (e.g., by searching the menu database 900) and forwards the results to the customer via the Web server.

### Customer Information Flow Diagrams—Kiosk Embodiment

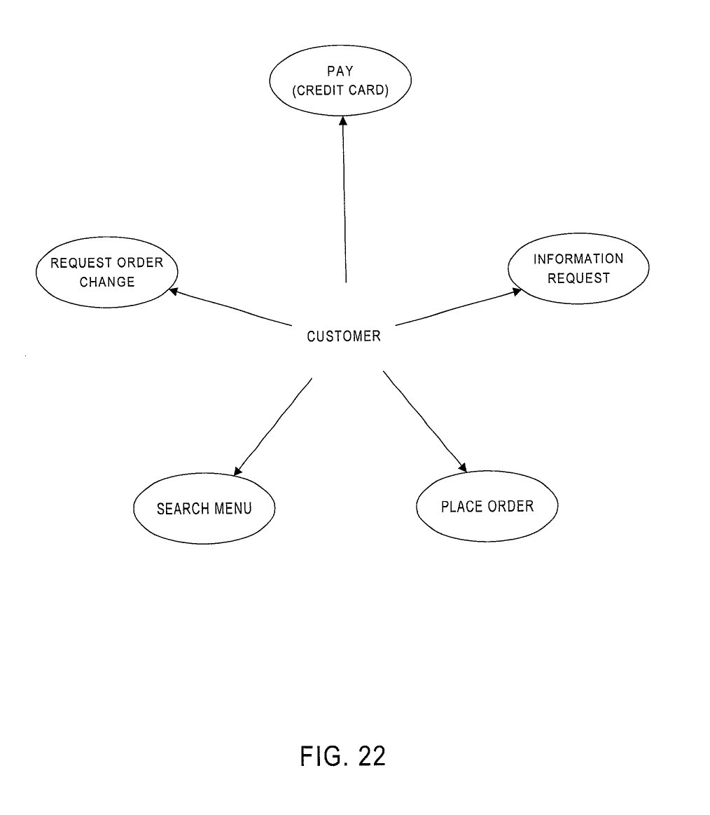

FIG. 22 is a customer state diagram according to another embodiment of the present invention wherein a customer uses a kiosk located at a restaurant (e.g., instead of or in addition to a wireless PDA 1130). As shown in FIG. 22, a customer may: request information, place an order, search a menu, change a request, and/or arrange for payment using a credit card. Many of these options are performed in the same manner described above with respect to the portable customer device embodiment.

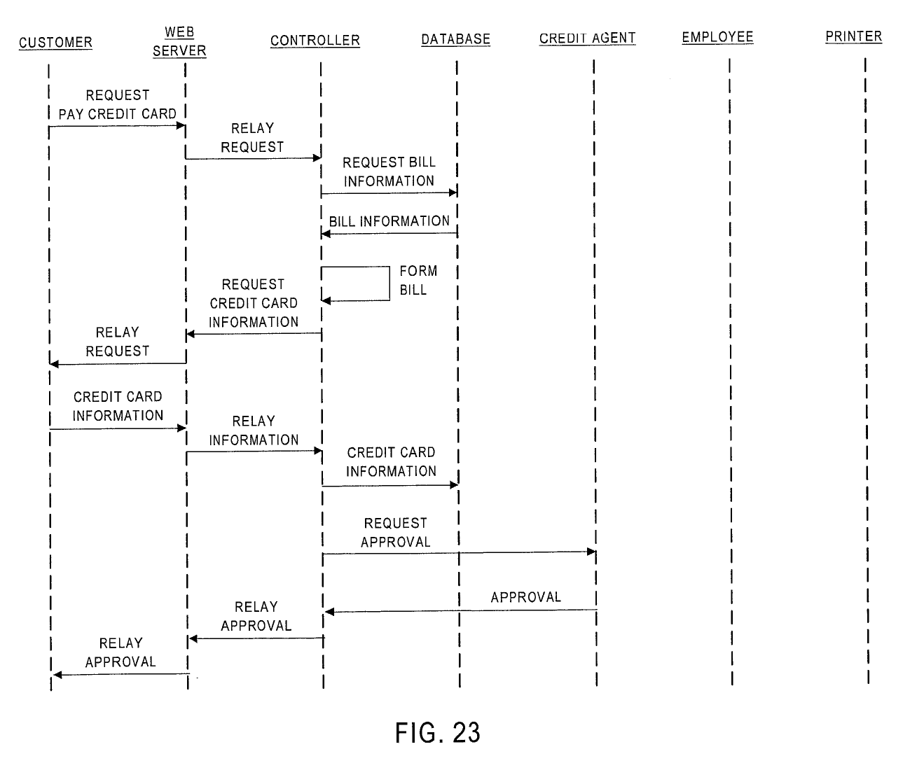

FIG. 23 illustrates an information flow when a customer arranges to provide payment using a credit card according to this embodiment of the invention. When a customer requests to close out his or her current account using a credit card (e.g., by selecting a link displayed at a kiosk), the request is relayed to the controller via the Web server. The controller requests and receives bill information from a database (e.g., from the transaction database 1000) and forms an appropriate bill page for the customer. The bill page is then transmitted to the customer along with a request for credit card information via the Web server.

The customer may then provide credit card information (e.g., by swiping a credit card and/or signing his or her name at the kiosk), and the information is relayed to the controller via the Web server. The controller then arranges to receive a credit approval from a credit agent, and relays the approval to the customer. According to another embodiment, the customer provides information (including, for example, an item selection and payment information) via a communication network such as the Internet.

### Employee Information Flow Diagrams

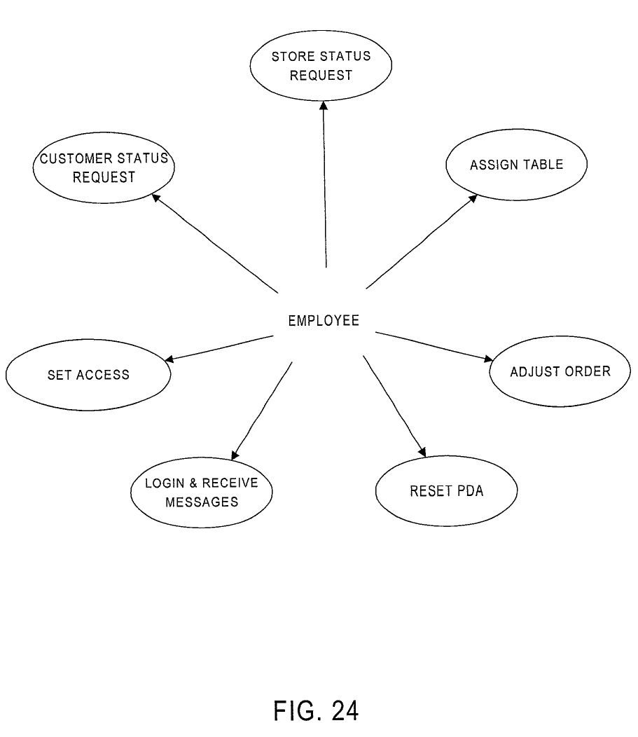

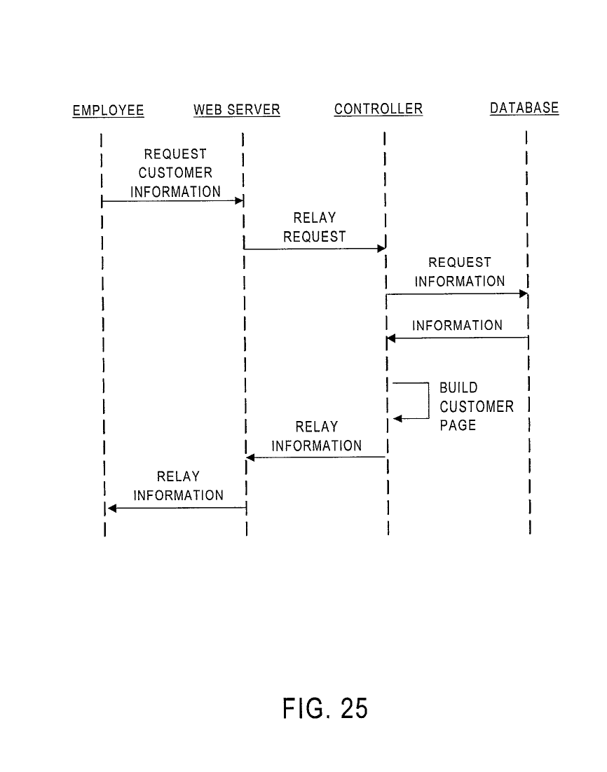

FIG. 24 is an employee state diagram according to an embodiment of the present invention. As shown in FIG. 24, an employee may: request a customer status, request a store status, assign a table to a customer, adjust an order, reset a PDA, login and receive messages, and/or set access to the system. FIGS. 25 to 30B are employee information flow diagrams according to this embodiment of the present invention.

FIG. 25 illustrates an information flow when an employee requests a customer status via the restaurant transaction system 1100. A request for customer information is relayed from the employee to the controller via the Web server. For example, an employee such as a waitperson can request to see the progress of a customer's order (e.g., whether an item is currently being prepared and/or how long the customer has been waiting to receive the item). The request may include a customer identifier, a device identifier (e.g., a device identifier displayed on a wireless PDA 1130), and/or a location identifier (e.g., a table number).

The controller then requests and receives information from a database (e.g., from the transaction database 1000). Based on the received information, the controller builds a page containing the appropriate information and relays the page to the employee via the Web server.

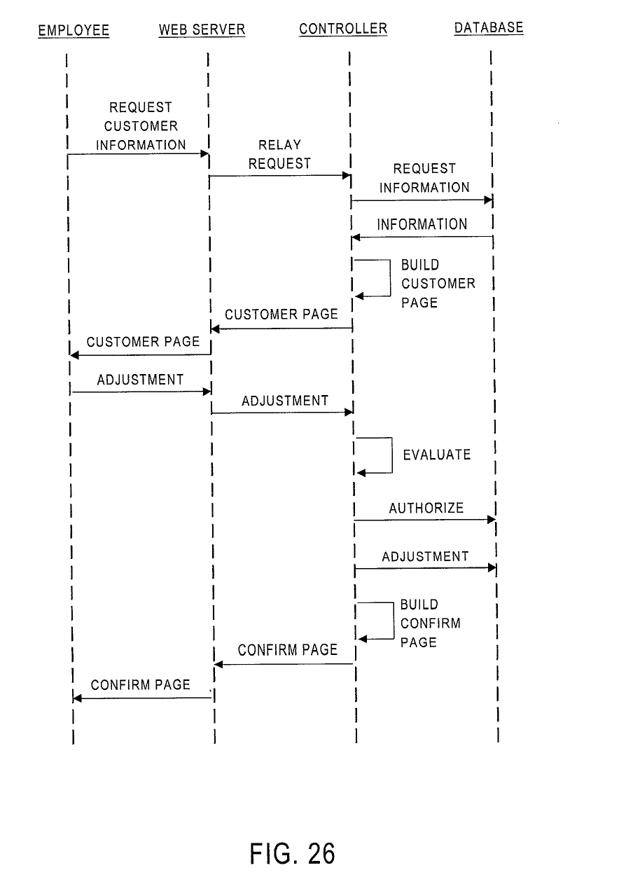

FIG. 26 illustrates an information flow when an employee adjusts an order via the restaurant transaction system 1100. A request for customer information is relayed from the employee to the controller via the Web server. For example, an employee such as a waitperson can request to see a customer's current order. The controller then requests and receives information from a database (e.g., from the transaction database 1000). Based on the received information, the controller builds a page containing the appropriate information and relays the page to the employee via the Web server.

The employee may then attempt to adjust the customer's order (e.g., by deleting, adding, or modifying an item or quantity). The adjustment is then relayed to controller via the Web server. The controller communicates with a database to determine a current status associated with the order, or with a particular item that the employee is attempting to adjust. For example, the controller may receive such information from the transaction database 1000. The controller evaluates the status, and authorizes the adjustment. For example, if the item status 1020 is “pending” (e.g., no employee has started to prepare the item), the adjustment may be authorized. The database is then updated by the controller, and a confirm page is built and transmitted to the employee. According to one embodiment, the controller also transmits information associated with the adjustment to another employee (e.g., an employee in the kitchen). Note that an employee may adjust a customer's bill using a similar approach. According to this embodiment, information about the adjustment may be stored, for example, in an audit database.

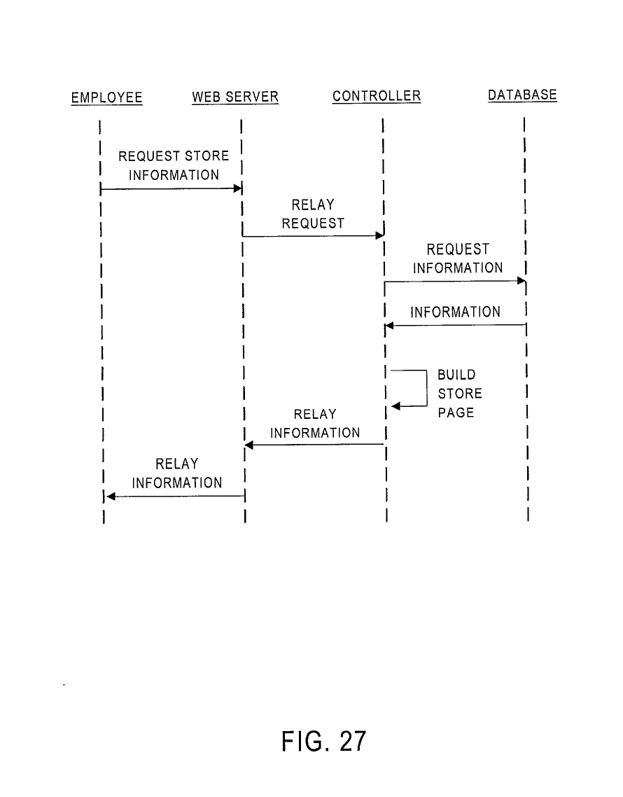

FIG. 27 illustrates an information flow when an employee requests store information via the restaurant transaction system 1100. A request for store information is relayed from the employee to the controller via the Web server. For example, an employee such as a manager can request to see the restaurant's table occupancy rate for the last five days. The controller then requests and receives information from a database. Based on the received information, the controller builds a page containing the appropriate information and relays the page to the employee via the Web server.

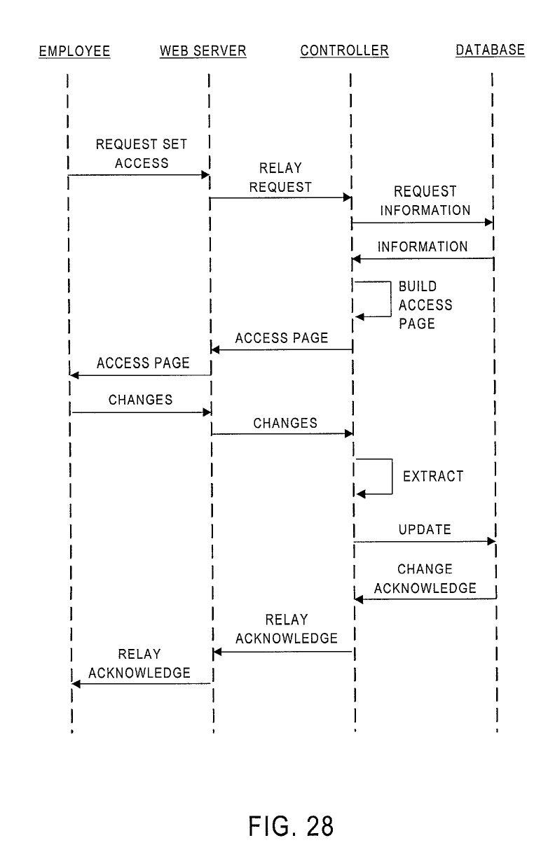

FIG. 28 illustrates an information flow when an employee sets access to the system via the restaurant transaction system 1100. A request to set access is relayed from the employee to the controller via the Web server. For example, an employee such as a manager can request to change the access or configuration of the restaurant transaction system 1100 (e.g., by adding or removing a wireless PDA 1130). The controller then requests and receives access information from a database. Based on the received access information, the controller builds a page containing the appropriate information and relays the page to the employee via the Web server. The employee may then enter his or her access changes. The changes are relayed to controller via the Web server, and the controller extracts the changes and updates the database. An acknowledge page is then built and transmitted to the employee.

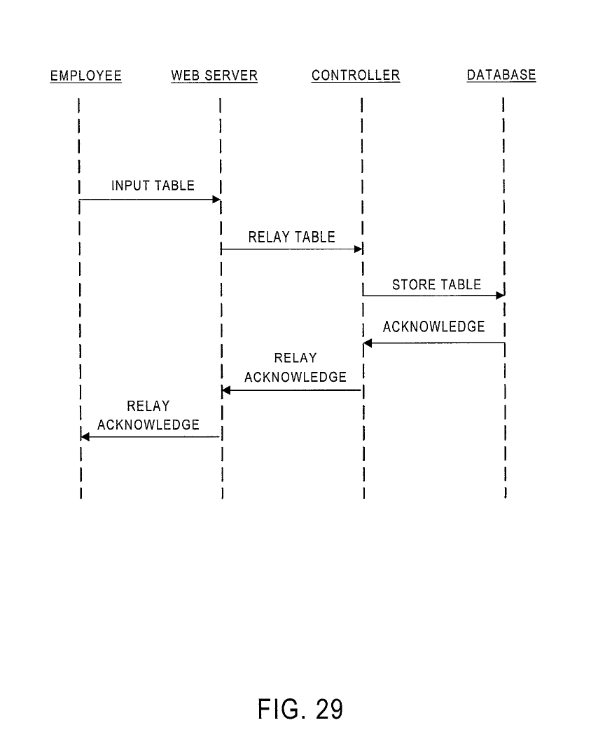

FIG. 29 illustrates an information flow when an employee assigns a table via the restaurant transaction system 1100. A request to assign a customer to a table location is relayed from the employee to the controller via the Web server. For example, an employee such as a host can request to assign a customer to particular table number. The request may include, for example, a customer identifier or a device identifier (e.g., a device identifier displayed on a wireless PDA 1130). The table information is stored in one or more databases (e.g., in the device database 500, the customer database 600, the location database 700, and/or the transaction database 1000) and an acknowledgement is relayed to the employee via the Web server. According to one embodiment, a map of the restaurant may be displayed to the employee to facilitate this process. According to another embodiment, the employee may also assign one or more customers particular seats at the table.

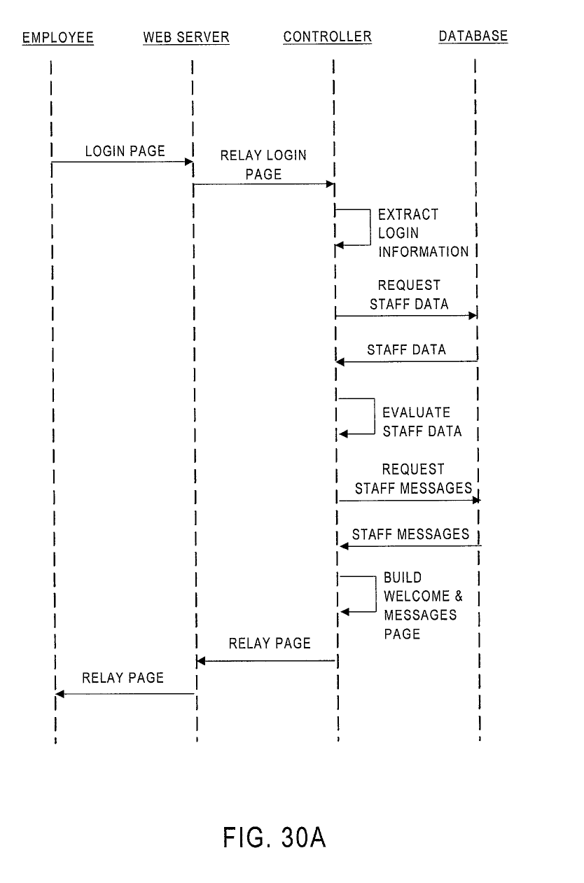

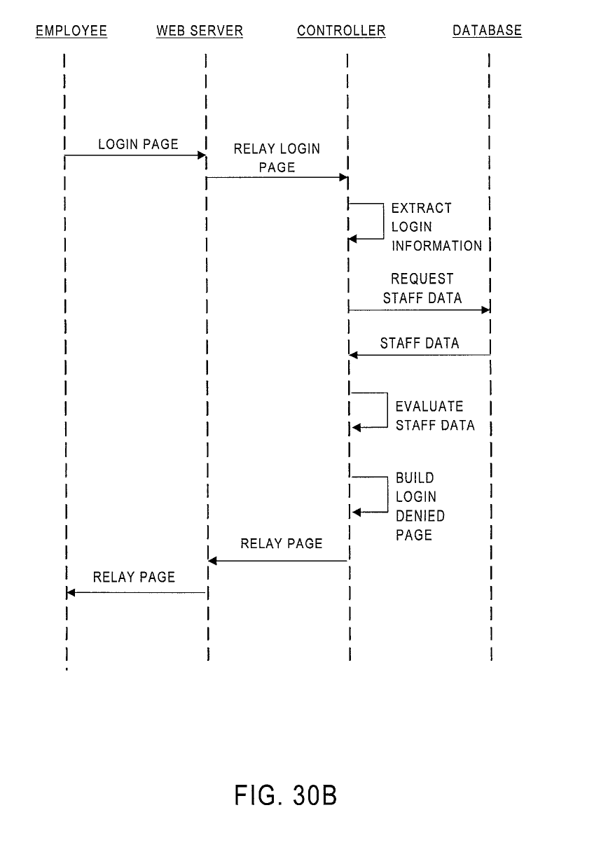

FIG. 30A illustrates an information flow when an employee logs in and receives messages via the restaurant transaction system 1100. Login information is relayed from the employee to the controller via the Web server. For example, an employee may enter his or her user name and password via a wireless PDA 1130. The controller extracts and evaluates the login information based on staff information stored in a database. If the login is successful, the controller requests and receives one or more “staff messages” to be displayed to the employee. For example, such a message may be from a co-worker or from a manager indicating when the next employee meeting will be held. A message may also contain information about a “daily special” being offered or about a new policy or procedure being used at the restaurant. The controller builds a welcome page for the employee, including any staff messages, and forwards the page to the employee via the Web server.

FIG. 30B illustrates an information flow when an employee unsuccessfully attempts to login via the restaurant transaction system 1100. Login information is relayed from the employee to the controller via the Web server. The controller extracts and evaluates the login information based on information stored in a staff database. If the login is not successful, the controller builds an “error—login denied” page and forwards the page to the employee via the Web server. Of course, no messages are displayed to the employee if the login is not successful.

Note that an employee may also reset a wireless PDA 1130 (e.g., when a customer is finished using the device). When the wireless PDA 1130 is reset, it may execute a setup routine and return to an initial state. For example, the wireless PDA 1130 may boot-up (e.g., including loading the native OS and the execution of a standard batch file), log onto the system, and load an initial browser page.

### EXAMPLE

To illustrate some embodiments of the present invention, consider Alice who enters her favorite restaurant. The restaurant is busy, and a host tells Alice that there will be a fifteen minute wait before a table is ready.

The host also asks Alice for her credit card. Alice provides her credit card to the host, who swipes the card through a card reading device. The device determines that the credit card is valid, and the host provides Alice with a wireless PDA 1130.

Alice goes to the restaurant's bar and orders a drink via the wireless PDA 1130. She also reads the menu via the wireless PDA 1130 and selects the entrée she would like to have for lunch. After fifteen minutes have passed, the host leads Alice to her table. Minutes later, the entrée Alice had selected while she was waiting at the bar is brought to her table. As she is finishing her lunch, Alice uses her wireless PDA 1130 to arrange to provide payment. When she is finished, Alice simply returns the wireless PDA 1130 to the host as she leaves the restaurant.

In this way, the wireless PDA 1130 is used by a customer to place orders (e.g., food, drink, and service orders) and to arrange for payment in a restaurant environment. This may reduce the time that it takes for the customer to order and pay for food (allowing more customers to be served) an reduce the number of mistakes and re-work that are necessary due to misstated and/or misunderstood orders. Such an approach may also allow waitpersons to be used more effectively and assist a manager of the establishment in managing the restaurant and it's employees.

### Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with a restaurant environment, the present invention may be used in any number of other environments. For example, a portable customer device may provided to someone who enters an amusement park, a hotel or a resort, a casino, a shopping mall, an airport, an automobile service station, a stadium (e.g., associated with a concert or sporting event), a supermarket or other retail store, or even a hospital.

According to another embodiment, the restaurant transaction system is used in a number of different restaurants (e.g., a number of related restaurants). In this way, information associated with one restaurant may be used to manage other restaurants.

The restaurant transaction system may also be used to track customer activity. For example, an electronic mail message offering a special discount may be sent to loyal customers, or to customers how have apparently stopped coming to the restaurant.

According to another embodiment, a customer may bring his or her own portable device. In this case, the customer may use the device to place an order before he or she is associated with a location (e.g., such as a particular table in a restaurant).

According to still another embodiment, an employee may perform any of the functions described herein with respect to a device. For example, an employee may manually associated a portable customer device 300 with a customer (e.g., by keeping a log of devices and associated customers).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating transactions, comprising:
associating a portable customer device with a customer;
receiving order information from the customer via the portable customer device; and
providing an item to the customer in response to the order information.

2. The method of claim 1, further comprising:
providing the portable customer device to the customer.

3. The method of claim 2, further comprising:
receiving a payment identifier from the customer to secure the portable customer device.

4. The method of claim 1, further comprising:
storing a customer identifier in association with a portable customer device identifier.

5. The method of claim 1, wherein said associating is performed before the customer is associated with a location.

6. The method of claim 5, wherein the location comprises at least one of: (i) a table location and (ii) a restaurant area location.

7. The method of claim 1, wherein said receiving the order information comprises receiving a one or more item selections.

8. The method of claim 1, wherein the order information comprises at least one of: (i) text information, (ii) audio information, and (iii) image information.

9. The method of claim 1, wherein the order information comprises at least one of: (i) a food order, (ii) a service order, (iii) an order update, (iv) an order cancellation, (v) customer preference information, (vi) timing information associated with an order, (vii) customer satisfaction information, (viii) a search term, and (ix) an item information request.

10. The method of claim 1, wherein said receiving is performed before the customer is associated with a location.

11. The method of claim 1, wherein said providing is performed before the customer is associated with a location.

12. The method of claim 1, wherein the item comprises at least one of: (i) a food product, and (ii) a service.

13. The method of claim 1, further comprising:
arranging for at least one of the portable customer device or the customer to be associated with a location,
wherein the item is provided to the customer at the location.

14. The method of claim 13, wherein the location is based on at least one of: (i) information received from the customer, (ii) information received from an employee, (iii) information received from the portable customer device, and (iv) information received from a table device.

15. The method of claim 1, further comprising:
transmitting item information to the customer via the portable customer device.

16. The method of claim 15, wherein the item information comprises a dynamically generated menu.

17. The method of claim 15, wherein the item information comprises at least one of: (i) text information, (ii) audio information, and (iii) image information.

18. The method of claim 15, wherein the item information comprises at least one of: (i) an item description, (ii) an item price, (iii) an item suggestion, and (iv) an item discount.

19. The method of claim 1, further comprising:
updating inventory information based on at least one of: (i) the order information, and (ii) said providing the item to the customer.

20. The method of claim 1, further comprising:
transmitting order information to an employee.

21. The method of claim 20, wherein the employee comprises at least one of: (i) a host, (ii) a waitperson, (iii) a kitchen employee, and (iv) a manager.

22. The method of claim 1, further comprising:
arranging for the customer to provide payment in exchange for the item.

23. The method of claim 22, wherein said arranging for the customer to provide payment comprises at least one of: (i) transmitting check information to the portable customer device, (ii) printing a check, (iii) transmitting receipt information to the portable customer device, (iv) printing receipt information, (v) processing a payment identifier associated with the customer, and (vi) receiving tip information from the portable customer device.

24. The method of claim 1, further comprising:
receiving a message from the customer via the portable customer device.

25. The method of claim 1, further comprising:
providing a message to the customer via the portable customer device.

26. The method of claim 25, wherein the message comprises at least one of: (i) an audible signal, and (ii) location information.

27. The method of claim 1, further comprising:
providing a supplemental service to the customer via the portable customer device.

28. The method of claim 1, further comprising:
arranging for information to be exchanged between the portable customer device and another portable customer device.

29. The method of claim 1, further comprising:
associating a plurality of portable customer devices with a location.

30. The method of claim 1, further comprising:
associating a plurality of customers with the portable customer device.

31. The method of claim 1, wherein the portable customer device comprises at least one of: (i) a portable computing device, (ii) a personal digital assistant, (iii) a telephone, (iv) a wireless telephone, and (v) a two-way pager.

32. The method of claim 1, wherein said receiving is performed via at least one of: (i) an Ethernet, (ii) a wireless network, (iii) a local area network, (iv) the Internet, (v) a intranet, (vi) a public network, and (vii) a proprietary network.

33. A computer-implemented method of facilitating restaurant transactions, comprising:
providing a personal digital assistant to a customer;
associating the personal digital assistant with the customer;
transmitting a dynamically generated menu to the personal digital assistant;
receiving a customer order from the personal digital assistant, the customer order comprising a list of food items selected from the dynamically generated menu;
transmitting order information to at least one restaurant employee;
associating the customer with a table location;
providing the selected food items to the customer at the table location in response to the order information;
calculating a total payment amount based on the selected food items; and
arranging for the customer to provide payment of the total payment amount.

34. A transaction system, comprising:
a plurality of portable customer devices; and
a controller in communication with the plurality of portable customer devices, said controller comprising:
a processor; and
a storage device in communication with said processor and storing instructions adapted to be executed by said processor to:
associate a first of the portable customer devices with a customer;
receive order information from the first portable customer device; and
arrange for an item to be provided to the customer in response to the order information.

35. A controller, comprising:
a processor; and
a storage device in communication with said processor and storing instructions adapted to be executed by said processor to:
associate a portable customer device with a customer;
receive order information from the portable customer device; and
arrange for an item to be provided to the customer in response to the order information.

36. The controller of claim 35, wherein said storage device further stores at least one of: (i) a device database, (ii) a customer database, (iii) a location database, (iv) an inventory database, (v) an item database, (vi) a transaction database, (vii) a preference database, (viii) a staff database, and (ix) a message database.

37. The controller of claim 35, further comprising:
a communication device coupled to said processor and adapted to communicate with at least one of: (i) the portable customer device, (ii) a manager device, (iii) a host device, (iv) a waitperson device, (v) a kitchen device, (vi) a payment device, and (vii) a printer.

38. A medium storing instructions adapted to be executed by a processor to perform a method of facilitating transactions, said method comprising:
associating a portable customer device with a customer;
receiving order information from the customer via the portable customer device; and
providing an item to the customer in response to the order information.

39. A portable customer order device, comprising:
a processor; and
a storage device in communication with said processor and storing instructions adapted to be executed by said processor to:
associate the portable customer device with a customer;
receive order information from the customer; and
transmit order information to a restaurant controller.

40. The portable customer device of claim 39, wherein said storage device further stores at least one of: (i) a menu database, (ii) a preference database, and (iii) a transaction database.

41. The portable customer device of claim 39, further comprising:
a communication device coupled to said processor and adapted to communicate with at least one of: (i) a controller, (ii) another portable customer device, (iii) a manager device, (iv) a host device, (v) a waitperson device, (vi) a kitchen device, (vii) a payment device, and (viii) a printer.

42. The portable customer device of claim 39, further comprising:
an input device coupled to said processor and adapted to receive information from the customer,
wherein the input device comprises at least one of: (i) a keyboard, (ii) a touch screen, (iii) a microphone, and (iv) a payment device.

43. The portable customer device of claim 39, further comprising:
an output device coupled to said processor and adapted to provide information to the customer,
wherein the output device comprises at least one of: (i) a display screen, (ii) a speaker, and (iii) a printer.

44. The portable customer device of claim 39, further comprising:
a location determining device coupled to said processor and adapted to determine a location associated with the customer.

45. A medium storing instructions adapted to be executed by a processor to facilitate restaurant transactions, said method comprising:
arranging for a portable customer device to be associated with a customer;
receiving order information from the customer; and
transmitting order information to a restaurant controller.

46. A method of placing an order in a restaurant, comprising:
receiving a portable customer device from the restaurant;
arranging to be associated with the portable customer device;
providing order information via the portable customer device; and
receiving an item in response to the order information.
